(19) United States
(12) Patent Application Publication
(10) Pub. No.: US 2005/0025460 A1
(43) Pub. Date: Feb. 3, 2005

(54) Information-processing apparatus, information-processing method, program-recording medium, and program

(76) Inventors: Kenji Hyodo, Kanagawa (JP); Tatsuji Yamazaki, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/885,037

(22) Filed: Jul. 7, 2004

(30) Foreign Application Priority Data
Jul. 9, 2003 (JP) P2003-272171

(51) Int. Cl. H04N 5/781

(52) U.S. Cl. 386/95; 386/125

(57) ABSTRACT

A file body of an MXF file having an AV multiplex format comprises one or more essence containers each having a size equal to the length of an annual ring. These essence containers are each managed as a movie data atom in the structure of a QT file. That is to say, since each essence container included in the file body of an MXF file is generated for each predetermined annual-ring length, the movie data atom included in the QT file as an atom corresponding to the essence container can also be composed of AV data having an amount equivalent to the length of an annual ring and the size of the movie data atom can be described in an mdat header of the atom. Thus, a file can be transmitted to another apparatus in an on-the-fly manner while imaging an object. To be more specific, a file can be transmitted between a broadcasting apparatus and a personal computer in a real-time manner. The present invention can be applied to a video-recording apparatus.

### BACKGROUND OF THE INVENTION

The present invention relates to an information-processing apparatus, an information-processing method, a program-recording medium, and a program. More particularly, the present invention relates to an information-processing apparatus making it possible to transmit a file between a broadcasting apparatus and a personal computer, relates to an information-processing method typically adopted in the information-processing apparatus, relates to a program implementing the information-processing method and relates to a program-recording medium for storing the program.

In recent years, with the progress in standardization such as adoption of a communication protocol and with reduced prices of communication apparatus, a personal computer having a communication I/F (interface) as a standard has been becoming popular.

Furthermore, in addition to the personal computer, most of business broadcasting apparatus such as an AV (Audio Visual) server and a VTR each have a communication I/F as a standard or allow a communication I/F to be incorporated therein so that a file containing video and audio data can be exchanged between such broadcasting apparatus. The video data and audio data are referred to hereafter as AV data, which is a generic name for them.

By the way, traditionally, as a typical format of a file to be exchanged between the broadcasting apparatus, an original format varying from apparatus to apparatus or from manufacturer to manufacturer is generally adopted. Thus, it is difficult to exchange a file between broadcasting apparatus of types different from each other or between broadcasting apparatus made by different manufacturers. In order to solve this problem, an MXF (Material exchange Format) has been proposed as a format for exchanging a file and has been becoming a standard. The MXF is described in WO02/21845 A1, which is referred to hereafter as patent reference 1.

However, a file of the MXF cited above is a file of a proposed format for exchanging a file between broadcasting apparatus of types different from each other or between broadcasting apparatus made by different manufacturers. Thus, the MXF raises a problem that an MXF file cannot be recognized by a general-purpose computer such as a personal computer. That is to say, the MXF raises a problem that the MXF cannot be used for exchanging a file between a business broadcasting apparatus and a personal computer.

In addition, in order to carry out a work between broadcasting apparatus with a high degree of efficiency, while a broadcasting apparatus is imaging an object, an MXF file is transmitted in a real-time manner to other apparatus in some cases. Even in such cases, however, the MXF cannot be recognized by a general-purpose computer such as a personal computer. Thus, the MXF raises another problem that, while imaging an object, a business broadcasting apparatus is not capable of transmitting an MXF file to a personal computer in a real-time manner.

### SUMMARY OF THE INVENTION

It is thus an object of the present invention addressing the problems described above to allow a file to be transmitted between a broadcasting apparatus and a personal computer in a real-time manner.

In accordance with the present invention, it is possible to exchange a file between a broadcasting apparatus and a personal computer. In addition, in accordance with the present invention, it is possible to transmit a file between a broadcasting apparatus and a personal computer in a real-time manner.

### BRIEF DESCRIPTION OF THE DRAWINGS

FIG. 1 is a diagram showing a typical configuration of an AV network system provided by the present invention;

FIG. 2 is a block diagram showing a typical configuration of a video-recording apparatus employed in the AV network system shown in FIG. 1;

FIG. 3 is an explanatory diagram referred to in description of data recorded on an optical disk used in the AV network system shown in FIG. 1;

FIG. 4 is a diagram showing a typical structure of a file used in the AV network system shown in FIG. 1 as a file having an AV multiplex format;

FIG. 5 is a diagram showing other typical structures of the file having the AV multiplex format shown in FIG. 4;

FIG. 6 is a diagram showing still further typical structures of the file having the AV multiplex format shown in FIG. 4;

FIG. 7 is a diagram showing a typical structure of a movie atom included in a file structure shown in FIG. 6;

FIG. 8 is a diagram showing a typical structure of a time sample atom included in the movie atom shown in FIG. 7;

FIG. 9 is a diagram showing a typical structure of a synchronization atom included in the movie atom shown in FIG. 7;

FIG. 10 is a diagram showing a typical structure of a sample chunk atom included in the movie atom shown in FIG. 7;

FIG. 11 is a diagram showing a typical structure of a sample size atom included in the movie atom shown in FIG. 7;

FIG. 12 is a diagram showing a typical structure of a chunk offset atom included in the movie atom shown in FIG. 7;

FIG. 13 is a diagram showing a typical structure of a file body in a file having the AV multiplex format shown in FIG. 5;

FIG. 14 is a diagram showing a typical structure of a sound item included in the file body shown in FIG. 13;

FIG. 15 is a diagram showing another typical structure of the file body in a file having the AV multiplex format shown in FIG. 5;

FIG. 16 is a diagram showing a typical structure of a picture item included in the file body shown in FIG. 13;

FIG. 17 shows a flowchart referred to in explanation of a process carried out by the video-recording apparatus shown in FIG. 1 to generate a file having the AV multiplex format;

FIG. 18 shows a flowchart referred to in explanation of a process carried out at a step S5 included in the flowchart shown in FIG. 17 to generate a file body;

FIG. 19 shows a flowchart referred to in explanation of a process carried out at a step S6 included in the flowchart shown in FIG. 17 to generate a header and a footer;

FIG. 20 is a diagram showing another typical configuration of the AV network system provided by the present invention;

FIG. 21 shows a flowchart referred to in explanation of typical processes carried out by the AV network system shown in FIG. 20; and

FIG. 22 shows a flowchart referred to in explanation of other typical processes carried out by the AV network system shown in FIG. 20.

### DETAILED DESCRIPTION OF THE PREFERRED EMBODIMENTS

Before describing preferred embodiments implementing the present invention, a relation associating configuration elements described in claims with concrete implementations in the embodiments is explained by giving examples as follows. The following particular description explaining such association merely confirms that a concrete implementation supporting an invention described in a claim is described in a preferred embodiment implementing the invention. Thus, a concrete implementation may be described in an embodiment implementing the present invention but not included in the particular description as a concrete implementation associated with a configuration element. In this case, the description of such a concrete implementation in the embodiment is not to be interpreted as a description meaning that the concrete implementation is not a concrete implementation corresponding to a configuration element. Conversely, an explanation of a concrete implementation in the particular description as an implementation associated with a specific configuration element described in a claim does not necessarily mean that the concrete implementation does not correspond to any of configuration elements other than the specific configuration element.

In addition, the following particular description is not to be interpreted as a description meaning that inventions each associated with a concrete implementation described in an embodiment implementing the invention are all described in claims. In other words, the particular description is to be interpreted as a description meaning that a specific invention associated with a concrete implementation described in an embodiment implementing the invention but not described in a claim may be an invention to be claimed later in the future in a separate application for a patent or added as an amendment to this specification, and is thus not to be interpreted as a denial to the existence of the specific invention.

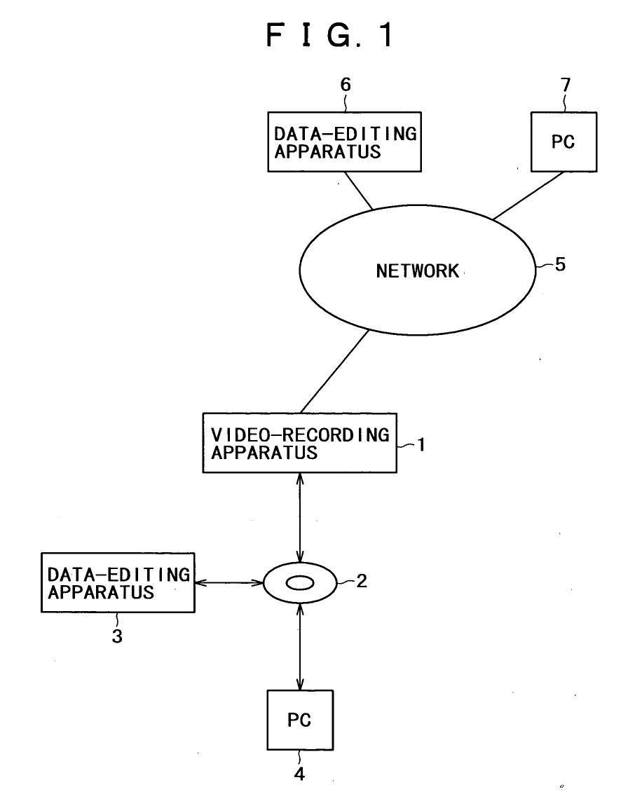

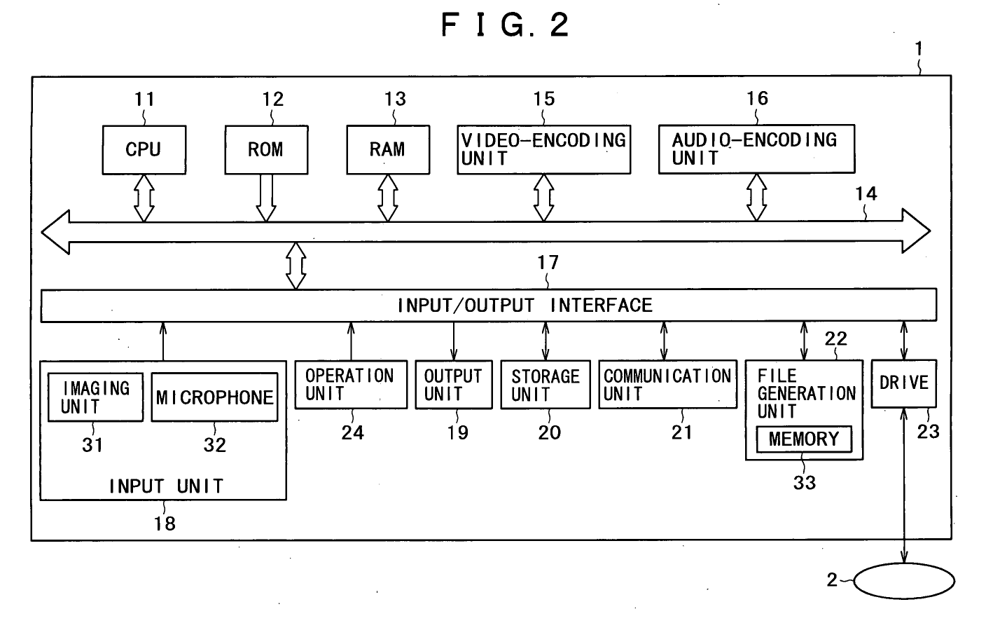

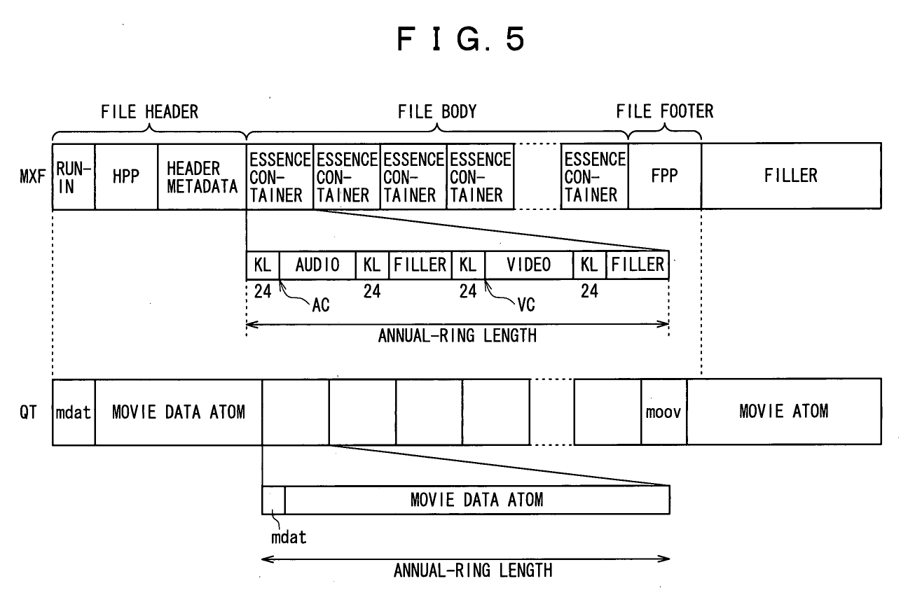

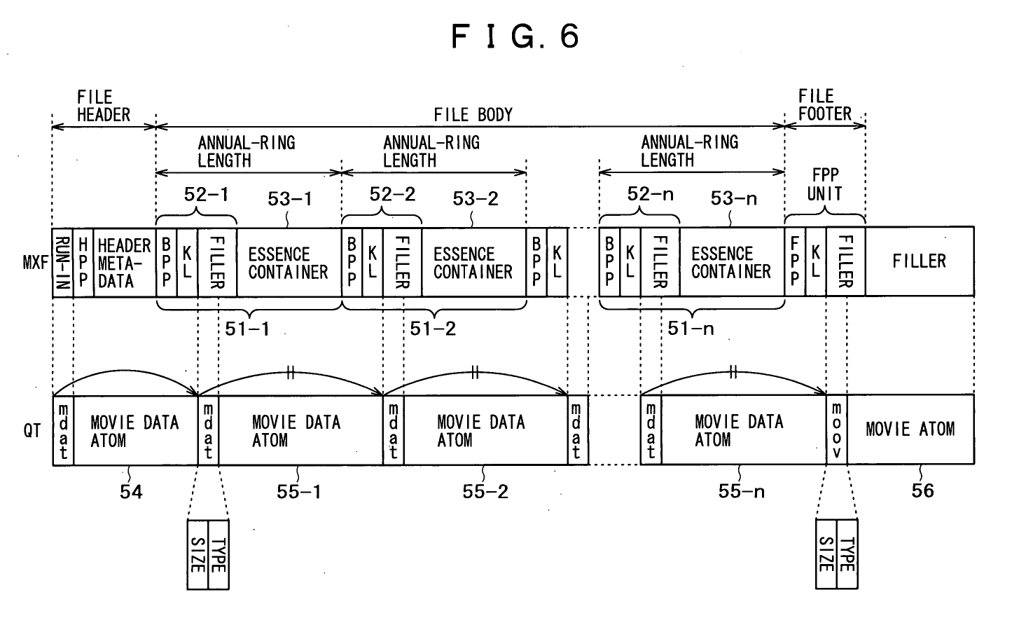

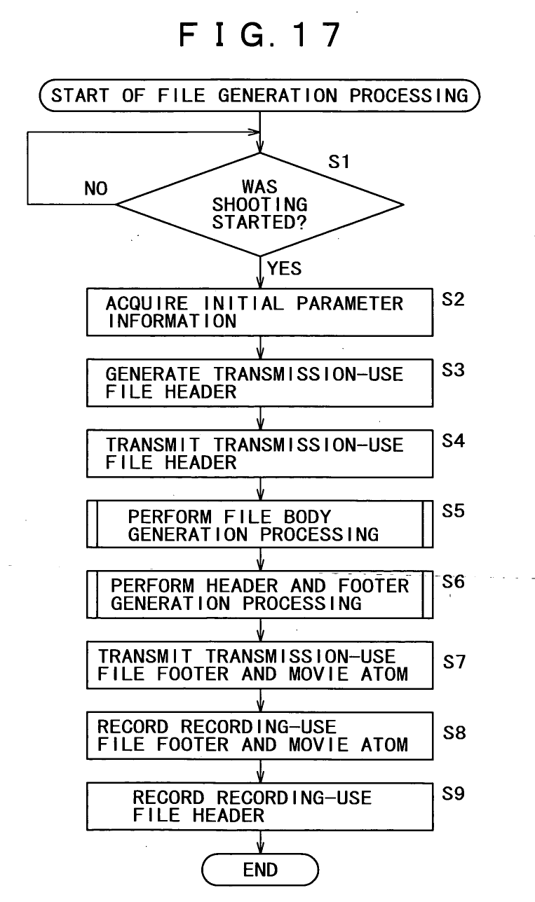

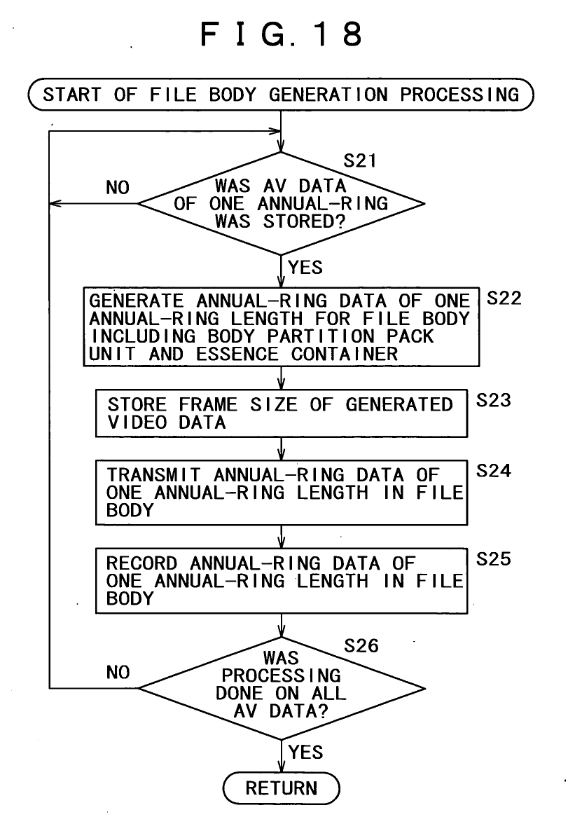

An information-processing apparatus described in claim 1 is an information-processing apparatus (such as a video-recording apparatus 1 shown in FIG. 1) for generating a file (such as a file having an AV multiplex format) having a format composed of a header (such as a file header shown in FIG. 5), a body (such as a file body shown in FIG. 5) following the header and a footer (such as a file footer shown in FIG. 5) following the body. The information-processing apparatus includes: data determination means (such as a file generation unit 22 shown in FIG. 2 as a unit carrying out processing of a step S21 included in a flowchart shown in FIG. 18) for determining whether or not data of an amount equal to a predetermined unit (such as an annual-ring length) has been stored in a memory (such as a memory 33 shown in FIG. 2); body generation means (such as the file generation unit 22 shown in FIG. 2 as a unit carrying out processing of a step S22 included in the flowchart shown in FIG. 18) for generating data (such as annual-ring data 51-1 shown in FIG. 6) composing the body for each predetermined unit in case the data determination means determines that data of an amount equal to the predetermined unit has been stored in the memory; size acquisition means (such as the file generation unit 22 shown in FIG. 2 as a unit carrying out processing of a step S23 included in the flowchart shown in FIG. 18) for acquiring the size (such as a frame size) of data generated by the body generation means as data composing the body; and table generation means (such as the file generation unit 22 shown in FIG. 2 as a unit carrying out processing of a step S6 included in the flowchart shown in FIG. 17) for generating table information (such as a movie atom shown in FIG. 5) to be placed after the footer on the basis of the size acquired by the size acquisition means as table information for reading out data composing the body.

An information-processing apparatus described in claim 3 further includes: header transmission means (such as a communication unit 21 shown in FIG. 2 as a unit carrying out processing of a step S4 included in a flowchart shown in FIG. 17) for transmitting a transmission-use header to an other information-processing apparatus (such as a data-editing apparatus 6 shown in FIG. 1); body transmission means (such as the communication unit 21 shown in FIG. 2 as a unit carrying out processing of a step S24 included in a flowchart shown in FIG. 18) for transmitting data composing a body generated for each predetermined unit to an other information-processing apparatus when data composing the body is generated by the body generation means described above after the transmission-use header is transmitted by the header transmission means; and footer transmission means (such as the communication unit 21 shown in FIG. 2 as a unit carrying out processing of a step S7 included in a flowchart shown in FIG. 17) for transmitting a footer and table information generated by the table generation means to an other information-processing apparatus after a body is transmitted by the body transmission means.

An information-processing apparatus described in claim 4 further includes: body recording means (such as a drive 23 shown in FIG. 2 as a unit carrying out processing of a step S25 included in a flowchart shown in FIG. 18) for recording data composing a body generated for each predetermined unit into a recording medium (such as an optical disk 2 shown in FIG. 1) when data composing the body is generated by the body generation means; footer recording means (such as a drive 23 shown in FIG. 2 as a unit carrying out processing of a step S8 included in a flowchart shown in FIG. 17) for recording a footer and table information at a location following a body recorded in the recording medium by the body recording means; and header recording means (such as a drive 23 shown in FIG. 2 as a unit carrying out processing of a step S9 included in a flowchart shown in FIG. 17) for recording a recording-use header at a location in front of a body recorded in the recording medium by the body recording means.

An information-processing method described in claim 5 is an information-processing method for generating a file having a format composed of a header, a body following the header and a footer following the body. The information-processing method includes: a data determination step (such as the step S21 included in a flowchart shown in FIG. 18) of determining whether or not data of an amount equal to a predetermined unit has been stored in a memory; a body generation step (such the step S22 included in the flowchart shown in FIG. 18) of generating data composing a body for each predetermined unit in case a determination result produced in processing carried out at the data determination step indicates that data of an amount equal to the predetermined unit has been stored in the memory; a size acquisition step (such as the step S23 included in the flowchart shown in FIG. 18) of acquiring the size of data generated in processing carried out at the body generation step as data composing the body; and a table generation step (such as the step S6 included in the flowchart shown in FIG. 17) of generating table information to be placed after the footer on the basis of the size acquired in processing carried out at the size acquisition step as table information for reading out data composing the body.

An information-processing method described in claim 7 further includes: a header transmission step (such as the step S4 included in a flowchart shown in FIG. 17) of transmitting a transmission-use header to an information-processing apparatus; a body transmission step (such as the step S24 included in a flowchart shown in FIG. 18) of transmitting data composing a body generated for each predetermined unit to the information-processing apparatus when data composing the body is generated in processing carried out at the body generation step after the transmission-use header is transmitted in processing carried out at the header transmission step; and a footer transmission step (such as the step S7 included in a flowchart shown in FIG. 17) of transmitting a footer and table information generated in processing carried out at the table generation step to the information-processing apparatus after a body is transmitted in processing carried out at the body transmission step.

An information-processing method described in claim 8 further includes: a body recording step (such as the step S25 included in a flowchart shown in FIG. 18) of recording data composing a body generated for each predetermined unit into a recording medium when data composing the body is generated in processing carried out at the body generation step; a footer recording step (such as the step S8 included in a flowchart shown in FIG. 17) of recording a footer and table information at a location following a body recorded in the recording medium in processing carried out at the body recording step; and a header recording step (such the step S9 included in a flowchart shown in FIG. 17) of recording a recording-use header at a location in front of a body recorded in the recording medium in processing carried out at the body recording step.

It is to be noted that a program-recording medium and a program, which are provided by the present invention, basically have the same configuration as the information-processing method provided by the present invention as described above. Thus, it is not necessary to repeat the explanation of the information-processing method for the program-recording medium and the program.

Preferred embodiments each implementing the present invention are explained by referring to diagrams as follows.

FIG. 1 is a diagram showing a typical configuration of an embodiment implementing an AV network system provided by the present invention where the technical term “system” means a set comprising a plurality of apparatus connected logically to each other without regard to whether or not the apparatus form a configuration enclosed in the same housing.

An optical disk 2 can be mounted onto or removed from a video-recording apparatus 1. While an object is being shot, the video-recording apparatus 1 generates a file having an AV multiplex format to be described later from video data of the object of imaging as well as audio data collected, and records the file onto the optical disk 2 mounted on the video-recording apparatus 1 in an on-the-fly manner or, as an alternative, the video-recording apparatus 1 outputs the file to a network 5. The video-recording apparatus 1 may also generate a file having an AV multiplex format from previously imaged video data of the object as well as collected audio data, and record the file onto the optical disk 2 or output the file to the network 5.

In addition, the video-recording apparatus 1 reads out a file having an AV multiplex format from the optical disk 2 mounted on the video-recording apparatus 1 or a storage unit 20 embedded in the video-recording apparatus 1 as shown in FIG. 2, and outputs the file having an AV multiplex format as a file read out from the optical disk 2 or the storage unit 20 to the network 5.

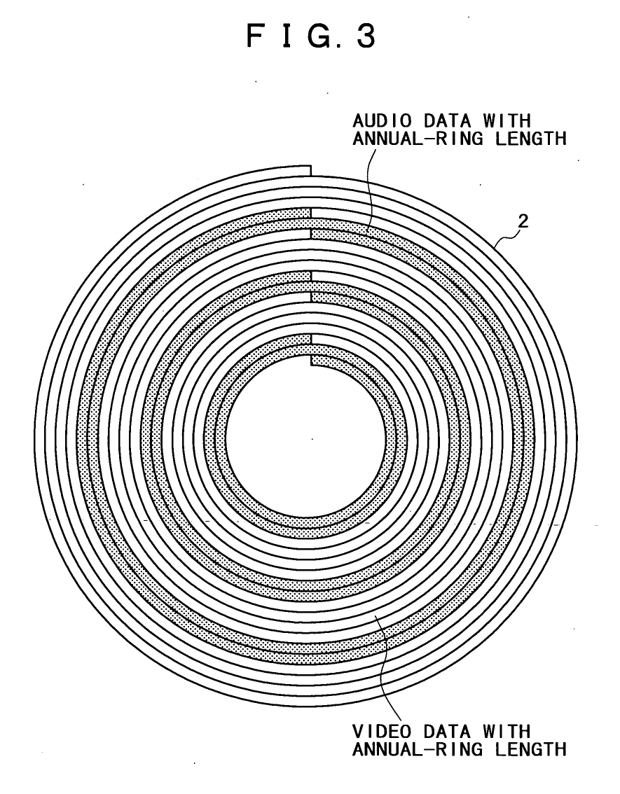

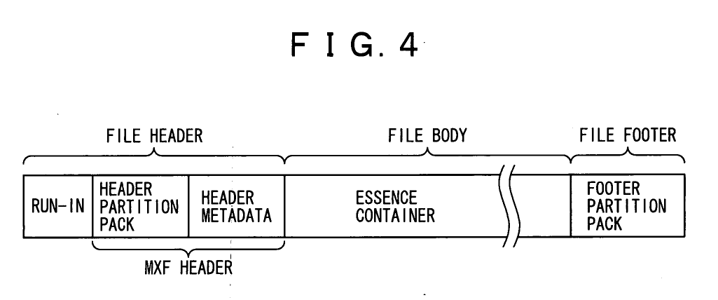

The file having an AV multiplex format as described above is a file conforming to MXF specifications. As will be explained later by referring to FIG. 4, the file having an AV multiplex format comprises a file header, a file body and a file footer. Then, since a file having an AV multiplex format is a file conforming to MXF specifications, the file body contains AV data comprising video data and audio data, which are laid out at multiplexed locations each having a dimension equal to the length of a predetermined unit referred to as an annual ring as will be described later by referring to FIG. 3. The length of the predetermined unit is referred to hereafter as an annual-ring length.

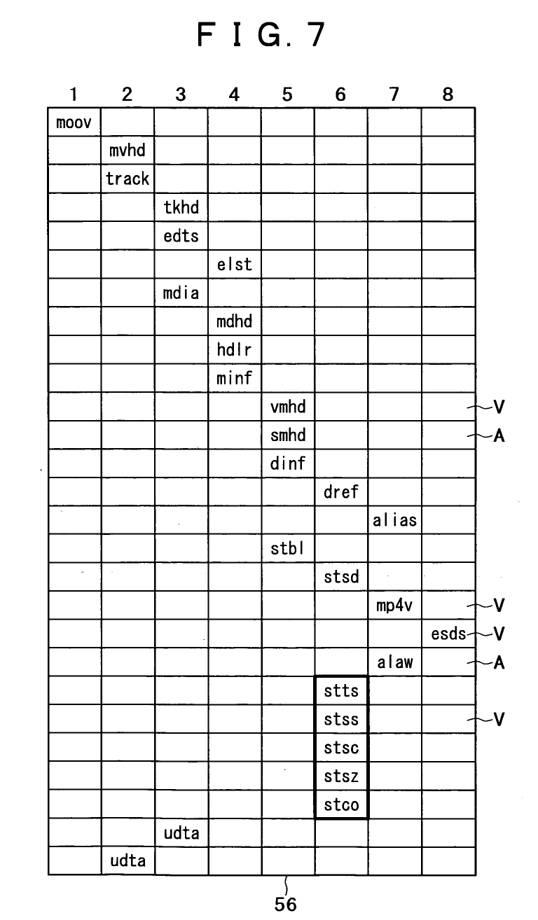

In addition, the file having an AV multiplex format is independent of the platform and compatible with a variety of recording formats. On the top of that, the file having an AV multiplex format has a file structure of QT (Quick Time: a trademark), which is expandable software. Furthermore, the file having an AV multiplex format is configured so that it can be reproduced and edited in an apparatus not conforming to the MXF specifications provided that the apparatus has the QT software. That is to say, the data stored in the file body of the file having an AV multiplex format is managed by the QT software in units each having a size equal to the length of an annual ring. At a location following the file footer of the AV multiplex format, information (that is, a sample table to be described later by referring FIG. 7) is stored. This information is required for reproducing and editing video and audio data by using the QT software. As described earlier, the video and audio data is stored in the file body conforming to the MXF specifications in units each having a size equal to the length of an annual ring.

In the typical configuration of an AV network system shown in FIG. 1, an optical disk 2 can be mounted on and removed from a data-editing apparatus 3 and a PC (Personal Computer) 4. The data-editing apparatus 3 is an apparatus conforming to the MXF specifications and thus capable of handling a file conforming to the MXF specifications. The data-editing apparatus 3 is thus capable of reading out video and audio data of a file having the AV multiplex format from an optical disk 2 mounted thereon. Then, the data-editing apparatus 3 carries out a streaming-reproduction process and/or an editing process on the retrieved video and audio data of a file having the AV multiplex format, storing the video and audio data of a file having the AV multiplex format onto the mounted optical disk 2 as a result of the editing process.

The PC 4 is not an apparatus conforming to the MXF specifications but an apparatus having the QT software. Thus, by using the QT software, the PC 4 is capable of reading out video and audio data of a file having the AV multiplex format from an optical disk 2 mounted thereon. That is to say, by using the QT software, the PC 4 reproduces information required for an editing process and a reproduction process using the QT software from a location following the file footer of the file having the AV multiplex format and, on the basis of the information, the PC 4 is capable of reading out video and audio data laid out in the file body of the file with the AV multiplex format in units each having a size equal to the length of an annual ring and carrying out an editing process on the data.

In the typical configuration of an AV network system shown in FIG. 1, much like the data-editing apparatus 3, a data-editing apparatus 6 connected to a network 5 is an apparatus conforming to the MXF specifications and thus capable of handling a file conforming to the MXF specifications. Thus, the data-editing apparatus 6 receives and reproduces a file with the AV multiplex format from the video-recording apparatus 1, which transmits the file to the data-editing apparatus 6 by way of the network 5. In addition, the data-editing apparatus 6 also receives a file with the AV multiplex format from the video-recording apparatus 1, which transmits the file to the data-editing apparatus 6 by way of the network 5 in the on-the-fly manner while shooting an object, and reproduces the received file with the AV multiplex format in a real-time manner.

Conversely, the data-editing apparatus 6 transmits a file with the AV multiplex format to the video-recording apparatus 1 by way of the network 5. That is to say, the video-recording apparatus 1 and the data-editing apparatus 6 are capable of exchanging a file with the AV multiplex format by way of the network 5. In addition, the data-editing apparatus 6 is capable of carrying out various kinds of processing including the streaming-reproduction process and the editing process on a received file with the AV multiplex format.

Much like the PC 4, on the other hand, a PC 7 connected to the network 5 is not an apparatus conforming to the MXF specifications but an apparatus having the QT software. Thus, the PC 7 is capable of receiving a file having the AV multiplex format from the video-recording apparatus 1 transmitting the file to the PC 7 by way of the network 5 and reproducing the file having the AV multiplex format. In addition, the PC 7 is also capable of receiving a file with the AV multiplex format from the video-recording apparatus 1, which transmits the file to the PC 7 by way of the network 5 in the on-the-fly manner while shooting an object. After the process to receive the file with the AV multiplex format is completed, the PC 7 is capable of reproducing the received file. Data laid out in the file body of the file with the AV multiplex format in units each having a size equal to the length of an annual ring as will be described later by referring to FIG. 5 is managed by a movie data atom of the QT software and information required for an editing process and a reproduction process using the QT software is placed at a location following the file footer. Thus, by using the QT software, the PC 7 is capable of reading out video and audio data laid out in the file body of the file with the AV multiplex format in units each having a size equal to the length of an annual ring and carrying out an editing process on the data on the basis of this information. In addition, the PC 7 is also capable of transmitting a file with the AV multiplex format to the video-recording apparatus 1 by way of the network 5.

As described above, a file having an AV multiplex format is a file conforming to MXF specifications, and video data as well as audio data are laid out in the file body conforming to MXF specifications in units each having a size equal to the length of an annual ring. In addition, information required for an editing process and a reproduction process carried out by using the QT software on the video data and the audio data, which are laid out in the file body conforming to MXF specifications in units each having a size equal to the length of an annual ring, is placed at a location following the file footer of the file having an AV multiplex format. Thus, by recording a file having an AV multiplex format onto the optical disk 2 or transmitting the file in a real-time manner, the video-recording apparatus 1 is capable of displaying compatibility with not only the data-editing apparatus 3 and 6, but also the general-purpose PCs 4 and 7.

That is to say, in the video-recording apparatus 1, the data-editing apparatus 3 and 6 each conforming to the MXF specifications as well as the PCs 4 and 7 each having the QT software, a file with the AV multiplex format can be recorded onto an optical disk 2 and transmitted in a real-time manner in order to exchange the file among the video-recording apparatus 1, the data-editing apparatus 3 and 6 as well as the PCs 4 and 7.

FIG. 2 is a diagram showing a typical configuration of the video-recording apparatus 1 provided by the present invention. In the typical configuration shown in FIG. 2, a CPU (Central Processing Unit) 11 carries out various kinds of processing by execution of programs stored in advance in a ROM (Read Only Memory) 12 or programs loaded from a storage unit 20 into a RAM (Random Access Memory) 13. The RAM 13 is also used for properly storing data required by the CPU 11 in the execution of the programs to carry out the various kinds of processing.

The CPU 11, the ROM 12 and the RAM 13 are connected to each other through a bus 14. The bus 14 is also connected to a video-encoding unit 15, an audio-encoding unit 16 and an input/output interface 17.

The video-encoding unit 15 encodes video data, which is input from an imaging unit 31, by adoption of an MPEG (Moving Picture Experts Group) 4 method and stores the encoded video data in a storage unit 20 or supplies the encoded video data to a file generation unit 22.

By the same token, the audio-encoding unit 16 encodes audio data, which is input from a microphone 32, by adoption of an ITU-TG.711A-Law method and stores the encoded audio data in the storage unit 20 or supplies the encoded audio data to the file generation unit 22.

It is to be noted that, in the present embodiment, the video-encoding unit 15 encodes video data having a resolution lower than video data of a main track actually used in real editing and reproduction processes. That is to say, the video-encoding unit 15 encodes video data of a small amount. However, the video-encoding unit 15 is capable of encoding video data with a resolution corresponding to, among others, a demanded quality or a demanded file size. By the same token, the audio-encoding unit 16 encodes audio data having a resolution lower than audio data of a main track actually used in real editing and reproduction processes. That is to say, the audio-encoding unit 16 encodes audio data of a small amount. However, the audio-encoding unit 16 is capable of encoding audio data with a resolution corresponding to, among others, a demanded quality or a demanded file size.

The input/output interface 17 is connected to an input unit 18, an output unit 19, the storage unit 20, a communication unit 21, the file generation unit 22, a drive 23 and an operation unit 24. The input unit 18 comprises the imaging unit 31 and the microphone 32. The imaging unit 31 is a component for imaging an object and inputting video data obtained as a result of imaging. The microphone 32 is a component for inputting audio data. The output unit 19 comprises a speaker and a monitor, which can be a CRT (Cathode Ray Tube) unit or an LCD (Liquid Crystal Display) unit. The operation unit 24 comprises buttons and a dial to be operated by typically an operator.

The storage unit 20 is typically a memory and/or a hard disk, which are used for storing video data generated by the video-encoding unit 15 and audio data produced by the audio-encoding unit 16.

The communication unit 21 is typically an IEEE (Institute of Electrical and Electronics Engineers)-1394 port, an USB (Universal Serial Bus) port, an NIC (Network Interface Card) for LAN (Local Area Network) connection, an analog modem, a TA (Terminal Adapter), a DSU (Digital Service Unit) or an ADSL (Asymmetric Digital Subscriber Line) to mention a few. The communication unit 21 is a component for exchanging a file having an AV multiplex format with apparatus such as the data-editing apparatus 6 and the PC 7 by way of the network 5, which can be typically the Internet or an intranet. The communication unit 21 may also be capable of exchanging a file having an AV multiplex format with apparatus such as the data-editing apparatus 6 and the PC 7 through a communication satellite or radio communication.

To put it concretely, every time the communication unit 21 receives pieces of data stored respectively in the header, body and footer of a file with the AV multiplex format from the file generation unit 22 generating the data, the communication unit 21 outputs the received data to the network 5. Conversely, the communication unit 21 receives a file with the AV multiplex format from the network 5 and supplies the file to the output unit 19 or the storage unit 20. It is to be noted that the communication unit 21 is also capable of reading out a file with the AV multiplex format from the storage unit 20 for temporarily storing the file, and outputting the file to the network 5.

The file generation unit 22 includes a memory 33 for temporarily storing video data produced by the video-encoding unit 15 and audio data produced by the audio-encoding unit 16. The file generation unit 22 temporarily stores video data produced by the video-encoding unit 15 and audio data produced by the audio-encoding unit 16 in the memory 33. As the amount of the stored video and audio data reaches the length of an annual ring, the file generation unit 22 generates data of a unit having a size equal to the length of an annual ring composing the body of a file with the AV multiplex format, and supplies the generated data to the communication unit 21 and the drive 23. In addition, the file generation unit 22 also generates the header and footer of the file with the AV multiplex format, supplying the file header and the file footer to the communication unit 21 and the drive 23. It is to be noted that, at that time, as will be described later in detail, two kinds of file header and two kinds of file footer are generated. One of the kinds is used for transmission whereas the other kind is used for recording. In addition, the file generation unit 22 generates a file with the AV multiplex format also from video and audio data stored in the storage unit 20, supplying the file to the communication unit 21 and the drive 23.

The drive 23 is designed so that an optical disk 2 can be mounted thereon and removed from it. By driving the optical disk 2 mounted thereon, the drive 23 records a file with the AV multiplex format from the file generation unit 22 onto the optical disk 2. To put it concretely, the drive 23 records a file with the AV multiplex format onto the optical disk 2 by storing the file body of the file received from the file generation unit 22, the file footer of the file at a location following the file body and the file header of the file at a location preceding the file body. The drive 23 also reads out a file having the AV multiplex format from the optical disk 2 and supplies the file to the output unit 19 or the storage unit 20.

FIG. 3 is a diagram showing a model of a track of an optical disk 2 on which audio and video data has been recorded. It is to be noted that, in the model shown in FIG. 3, a portion for recording audio data is shown as a hatched circle and a portion for recording video data is not shown as a special pattern.

In the typical model shown in FIG. 3, video data and audio data are alternately recorded on the optical disk 2 at predetermined uniform reproduction time bands resembling annual rings of a tree. In this model, the predetermined reproduction time band has a length of 2 seconds. In such a recording state, a set of video and audio data recorded on the optical disk 2 is referred to as an annual ring and the predetermined reproduction time band is referred to as an annual-ring length.

As described above, on the optical disk 2, audio data of the uniform 2-second annual-ring length and video data of the uniform 2-second annual-ring length are recorded at locations close to each other. Thus, audio data and video data having the same reproduction time as the audio data can be read out and reproduced from the optical disk 2 speedily. That is to say, in the video-recording apparatus 1, data of a file body is set in advance in such a way that the data can be reproduced in such units each having a size equal to the length of an annual ring.

FIG. 4 is a diagram showing a typical structure of a file having the AV multiplex format. In the typical structure shown in FIG. 4, the file having the AV multiplex format conforms to the MXF specifications described in patent reference 1 cited earlier. The file comprises a file header at the head of the file, a file body following the file header and a file footer at the end of the file.

The header of a file having the AV multiplex format typically includes a run-in at the beginning followed by an MXF header comprising a header partition pack and a header metadata at the end of the header.

The run-in is optional. If the run-in is a pattern of 11 bytes, the run-in can be interpreted as the beginning of an MXF header. While an area up to 64 kilobytes can be allocated to the run-in, in the case of this embodiment, the run-in has a length of 8 bytes. The run-in can be any data as long as the data is not an 11-byte pattern of the MXF header. The header partition pack includes an 11-byte pattern for identifying the header and information indicating the format of data stored in the file body and indicating the format of the file.

The header metadata is information required by the data-editing apparatus 6 conforming to the MXF specifications in reading AV data from an essence container forming the file body as will be described later. As described earlier, the AV data comprises video and audio data. Thus, normally, the header metadata of the file header is created on the basis of a created file body after the file body and a file footer have been generated. For applications such as a case in which data is generated in a shooting operation, transmitted in the on-the-fly manner to a reception side and reproduced by the reception side in a real-time manner while an object is being shot, however, it is necessary to initially transmit the file header to the reception side before the operation to generate the file body is completed.

In spite of the fact that it is necessary to initially transmit the file header to the reception side before the operation to generate the file body is completed, some specific information included in the header metadata of the file header cannot be acquired until the operation to generate and record the data of the file body is completed. Examples of the specific information are the recording duration and size of the video data. Nevertheless, the data can be reproduced from the start of the data in a real-time manner even if such specific information is not available yet. Thus, in the applications such as the case described above, dummy data is recorded as the specific information in an operation to generate the file header. An example of the dummy data is −1 or 0, which never actually appears as a value of the specific information. The actual values of the specific information represented by the dummy data become known at the end of the operation to generate and record the data of the file body. When the actual values become known, the values are recorded in the file footer as metadata. It is to be noted that a file header including dummy data as a portion of the header metadata thereof is properly referred to as a transmission-use file header to distinguish such a header from the ordinary file header including no dummy data as a portion of the header metadata thereof.

The data-editing apparatus 6 conforming to the MXF specifications receives a file with the AV multiplex format while an object represented by the file is being shot. The data-editing apparatus 6 is then capable of reproducing the received file in a real-time manner, starting from the beginning of the file on the basis of the transmission-use file header of the file. It is to be noted that, if the file with the AV multiplex format is to be reproduced after the operation to receive the file is completed, the data-editing apparatus 6 conforming to the MXF specifications is capable of reproducing the file on the basis of the transmission-use file header and metadata recorded in the file footer of the file. Thus, the data-editing apparatus 6 is capable of reproducing the file with the AV multiplex format not only from the beginning of the file, but also from any desired position on the file.

As described above, the essence container forms the file body of a file with the AV multiplex format. The essence container contains AV data comprising video data and audio data, which are laid out in a multiplexed way in units each having a size equal to the annual ring-length described earlier by referring to FIG. 3.

The file footer of a file with the AV multiplex format is composed of a footer partition pack including data for identifying the file footer. In addition, as described above, the actual values of dummy data described above are recorded in the file footer as metadata at the end of the operation to generate the file body. It is to be noted that a file footer including such metadata is properly referred to as a transmission-use file footer in order to distinguish such a file footer from the ordinary file footer including no metadata.

When receiving a file with the AV multiplex format having the structure described above, first of all, the data-editing apparatus 3 or 6 reads out a pattern with a length of 11 bytes from the header partition pack in order to find the MXF header. Then, the data-editing apparatus 3 or 6 is capable of reading out AV data comprising video and audio data from the essence container on the basis of the metadata of the MXF header.

FIG. 5 is a diagram showing other typical AV multiplex formats. It is to be noted that the upper portion of FIG. 5 showing the typical AV multiplex format is the format of an MXF file while the lower portion is the format of a QT file. The MXT file is a file with the AV multiplex format explained earlier by referring to FIG. 4. The MXT file is a file recognized by the data-editing apparatus 3 and 6 each conforming to the MXF specifications. On the other hand, the QT file is a file recognized by the PCs 4 and 7 each having the QT software. That is to say, the AV multiplex format can be the format of an MXF file or the format of a QT file.

As is obvious from the upper portion of the figure, as a file having the structure of an MXF file, the file with the AV multiplex format comprises a file header, a file body, a file footer and a filler. The file header comprises a run-in having a length of 8 bytes, an HPP (header partition pack) and header metadata. The file body includes a plurality of essence containers. The file footer is an FPP (footer partition pack). The filler is data for a stuffing purpose.

In the typical MXF format shown in FIG. 5, the file body includes one or more essence containers, which each have a size equal to the length of an annual ring. In the case of this embodiment, the length of an annual ring is 2 seconds. In the case of NTSC video data, the length of an annual ring is equivalent to 60 frames. Thus, an essence container having a size equal to the length of one annual ring includes AV data of 60 frames and other information, which have completed a KLV (Key, Length and Value) coding process and are laid out to form a KLV structure.

The KLV structure is a sequential structure beginning with a key followed by a length and ending with a value. The key is a 16-byte label conforming to SMPTE 298M specifications. The key indicates what kind of data the value is. The length has a size of 8 bytes indicating the length of data included in the structure in accordance with BER (Basic Encoding Rules: ISO/IEC882-1 ASN) as the value. The value is the actual data, which can be video or audio data of one annual-ring length equivalent to 60 frames in the case of the NTSC system. A filler is stuffing data included for the purpose of making length of the video or audio data fixed. Placed at a location following the video or audio data, the filler also has the KLV structure.

Thus, the essence container having one annual-ring length begins with audio data (AUDIO) with the KLV structure followed by a filler with the KLV structure followed by video data (VIDEO) with the KLV structure and ends with a filler with the KLV structure.

As is obvious from the lower portion of the figure, as the other structure of a file with the AV multiplex format, the structure of a QT file comprises a head mdat header, a head movie data atom following the head mdat header, a plurality of sets, which each comprises an mdat header and a movie data atom, following the head movie data atom, a movie atom header (moov) following the last movie data atom and a movie atom following the movie atom header.

In the structure of the QT file, the basic data unit is called an atom. Each atom has a header, which includes information of a 4-byte size and a 4-byte type. A movie data atom is an atom containing data such as video or audio data.

In the formats shown in FIG. 5, the head mdat header of the head movie data atom comprises information on the size and type of the head movie data atom, and is what is described in the run-in in the file header of the MXF file. The head movie data atom comprises the header metadata and header partition pack (HPP) of the file header of the MXF file. The mdat headers of the second and subsequent movie data atoms (that is, the movie data atom second from the head and the movie data atoms following the second movie data atom) each comprise information on the size and type of the movie data atom preceded by the mdat header. The second and subsequent movie data atoms are each what is described in the corresponding essence container of the file body of the MXF file. As described above, each of the essence containers has a size equal to the length of an annual ring. That is to say, a movie data atom is a management object contained in the corresponding essence container. The management object contained in an essence container is AV data of an amount equivalent to the length of an annual ring. The moov header of the movie atom comprises information on the size and type of the movie atom following the moov header, and is what is described as a portion of the file footer of the MXF file. The movie atom following the moov header comprises fixed information such as a sample table described in a portion of the file footer of the MXF file and the filler of the MXF file. The fixed information such as a sample table is information used for reading out AV data recorded in the movie data atom.

It is to be noted that, in the structure of the QT file, a smallest unit of audio and video data recorded in a movie data atom is referred to as a sample. A chunk is defined as a set of samples. That is to say, audio and video data placed in an edit unit in the QT file is recognized as individual chunks. Thus, in the QT file, a key and length of audio data placed in an edit unit of the MXF file are ignored. A start position AC of the audio data is recognized as the start position AC of the chunk. On the basis of that, information required for reading out the audio data is described in a movie atom. By the same token, a key and length of video data placed in an edit unit of the MXF file are ignored. A start position VC of the video data is recognized as the start position VC of the chunk. On the basis of that, information required for reading out the video data is described in a movie atom.

By providing the structures described above, the data-editing apparatus 3 and 6 each conforming to the MXF specifications as well as the PCs 4 and 7 each having the QT software are capable of recognizing a file with the AV multiplex format and reading out audio and video data recorded in the file body of the file.

That is to say, first of all, the data-editing apparatus 3 and 6 each conforming to the MXF specifications ignore the run-in and finds the MXF header by reading out the 11-byte pattern of the header partition pack. Then, on the basis of header metadata of the MXF header, AV data placed in each of essence containers can be read out. As described earlier, the AV data comprises video and audio data.

On the other hand, the PCs 4 and 7 each having the QT software first read out a movie atom. Then, on the basis of information described in the movie atom, the PCs 4 and 7 are capable of reading out a chunk recorded in each of movie data atoms. An example of the information described in the movie atom is a sample table to be described later. As explained above, the chunk comprises audio and video data.

As described above, it is possible to exchange a file having the AV multiplex format among the video-recording apparatus 1, the PCs 4 and 7 each having the QT software as well as the data-editing apparatus 3 and 6 each conforming to the MXF specifications.

FIG. 6 is a diagram showing more detailed typical structures of the AV multiplex format. It is to be noted that, in the typical structures shown in FIG. 6, the explanation of elements identical with those employed in the typical structures shown in FIG. 5 is not repeated to avoid duplications.

In the case of the typical structures shown in FIG. 6, as is obvious from the upper portion of the figure, in the structure of an MXF file, the MXF file body comprises n pieces of annual-ring data 51-1 to 51-n each having a size equal to the length of an annual ring. The pieces of annual-ring data 51-1 to 51-n in the file body comprise BPP (body partition pack) units 52-1 to 52-n and essence containers 53-1 to 53-n, respectively.

In the upper typical structure shown in FIG. 6, as described above, the file body includes the annual-ring data 51-1 comprising the body partition pack unit 52-1 and the essence container 53-1, the annual-ring data 51-2 comprising the body partition pack unit 52-2 and the essence container 53-2, - - - , and the annual-ring data 51-n comprising the body partition pack unit 52-n and the essence container 53-n. It is to be noted that, in the following description, a generic technical term annual-ring data 51 is simply used if it is not necessary to distinguish the pieces of annual-ring data 51-1 to 51-n from each other. By the same token, a generic technical term body partition pack unit 52 is simply used if it is not necessary to distinguish the body partition pack units 52-1 to 52-n from each other. In the same way, a generic technical term essence container 53 is simply used if it is not necessary to distinguish the essence containers 53-1 to 53-n from each other.

The body partition pack unit 52 includes a body partition pack and a filler provided for the purpose of making the length of the body partition pack unit 52 fixed. The filler has a KLV structure. The body partition pack includes an offset relative to the beginning of the file and a preceding offset also relative to the beginning of the file. The preceding offset is the offset included the body partition pack of the preceding body partition pack unit. It is to be noted that the body partition pack of the first body partition pack unit 52-1 also includes an offset relative to the beginning of the file and a preceding offset relative to the beginning of the file. In the case of the body partition pack of the first body partition pack unit 52-1, however, the preceding offset is the offset included in the header partition pack.

As described above, each essence container 53 is preceded by a body partition pack unit 52, which includes an offset for the essence container 53 itself and a preceding offset included in the preceding body partition pack unit, so that the data-editing apparatus 6 conforming to the MXF specifications is capable of recognizing the range of each essence container 53 included in annual-ring data 51 having a size equal to the length of an annual ring. Thus, in the AV multiplex format, a plurality of essence containers 53 each contained in annual-ring data 51 having a size equal to the length of an annual ring can be included in the file body.

In addition, the footer partition pack unit of the file footer has the same structure as the body partition pack unit 52 described above. That is to say, the footer partition pack unit comprises a footer partition pack and a KLV-structured filler provided for the purpose of making the length of the footer partition pack unit fixed.

On the other hand, as is obvious from the lower portion of the figure, the QT-file structure of a file having the AV multiplex structure comprises a movie data atom 54 corresponding to the file header of an MXF file, n movie data atoms 55-1 to 55-n corresponding to respectively the n essence containers 53-1 to 53-n of the MXF file and a movie atom 56. The movie data atom 54 has a structure ranging from the beginning of the MXF file to the KL portion of the body partition pack unit 52-1 of the MXF file. The movie data atom 54 starts with an mdat header, which is what is described in the run-in of the file header of the MXF file. The movie data atom 55-1 has a structure ranging from the filler of the body partition pack unit 52-1 to the KL portion of the body partition pack unit 52-2 of the MXF file. The mdat header of movie data atom 55-1 is what is described at the beginning of the filler of the body partition pack unit 52-1.

By the same token, the movie data atom 55-2 has a structure ranging from the filler of the body partition pack unit 52-2 to the KL portion of the body partition pack unit 52-3, and the mdat header of movie data atom 55-2 is what is described at the beginning of the filler of the body partition pack unit 52-2. In the same way, the movie data atom 55-n has a structure ranging from the filler of the body partition pack unit 52-n to the KL portion of the footer partition pack unit, and the mdat header of movie data atom 55-n is what is described at the beginning of the filler of the body partition pack unit 52-n.

The movie atom 56 has a structure ranging from the filler of the footer partition pack unit to the tail of a filler following the footer partition pack unit. The tail of a filler following the footer partition pack unit is the tail of the file having the AV multiplex format. The moov header of the movie atom 56 is what is described at the beginning of the filler of the footer partition pack unit.

In the video-recording apparatus 1, the size of the file header is set at 64 KB in advance. In addition, the body partition pack and the KL portion, which are included in the body partition pack unit 52-1, have a fixed length α. Thus, data managed as the movie data atom 54 has a size of (64 KB+α). In addition, the pieces of annual-ring data 51-1 to 51-n each have a structure of a unit having a size equal to the length of an annual ring. Thus, data managed as each of the pieces of movie data atom 55-1 to 55-n has a size equal to the annual-ring length of (64 KB−8). It is to be noted that, in the case of this embodiment, the unit having a size equal to the length of an annual ring is a 2-second unit, which is equivalent to 64 KB×8 (=64 KB×6 GOP for the NTSC system+64 KB×2 for audio data).

As described above, the file body has a structure comprising a plurality of essence containers each having a size equal to the annual-ring length set in advance. Thus, the size of each movie data atom can be acquired from the mdat header of the movie data atom corresponding to an essence container and, therefore, the movie data atom can be created. On the basis of generated movie data atoms, pieces of table information can be generated in the movie atom. It is to be noted that, in this case, the size of each movie data atom is equal to the length of an annual ring.

Thus, while shooting an object, the video-recording apparatus 1 transmits a file having the AV multiplex format in the on-the-fly manner in units each having a size equal to the annual-ring length set in advance to the data-editing apparatus 6 and/or the PC 7. Thus, the data-editing apparatus 6 receiving the file having the AV multiplex format is capable of reproducing the file in a real-time manner. In addition, the PC 7 is also capable of reproducing the file having the AV multiplex format after receiving the file.

Next, by referring to FIG. 7, information described in the movie atom is explained in detail.

FIG. 7 is a diagram showing a typical structure of the movie atom 56 included in the QT structure shown in FIG. 6. The upper portion of the typical structure shown in FIG. 7 is a portion close to the beginning of the file. It is to be noted that, in the case of this embodiment, the movie atom 56 comprises hierarchical layers 1 to 8. Hierarchical layer 1 on the left side is the layer of the highest level. Notation V on the right side of the figure indicates that a track atom to be described later is an atom described only for a case in which target media is video data. That is to say, notation V indicates that the track atom is a video track atom, which is a track atom of video data. On the other hand, notation A on the right side of the figure indicates that the track atom is an atom described only for a case in which the target media is audio data. That is to say, notation A indicates that the track atom is an audio track atom, which is a track atom of audio data.

In the case of the typical structure shown in FIG. 7, the movie atom 56 includes the moov header, a movie header atom (mvhd), a track atom (track) and a user data atom (udta). The moov header is the header of the movie atom and placed on hierarchical layer 1 at the highest level. On the other hand, the movie header atom (mvhd), the track atom (track) and the user data atom (udta) are placed on hierarchical layer 2.

The movie header atom on hierarchical layer 2 comprises information on a movie as a whole. The information on a movie as a whole includes the size, type, timescale and length of the movie. The track atom exists for each media. Examples of the track atom are a video track atom and an audio track atom, which are cited above. It is to be noted that, in the case of four-channel audio data, there are two audio track atoms and, in the case of eight-channel audio data, there are four audio track atoms. The track atom on hierarchical layer 2 comprises a track header atom (tkhd), an edit atom (edts), a media atom (mdia) and a user data atom (udta), which are shown on hierarchical layer 3.

The track header atom on hierarchical layer 3 comprises characteristic information of a track atom in the movie. The characteristic information includes an ID number of the track atom. The edit atom on hierarchical layer 3 includes an edit list atom (elst) on hierarchical layer 4. The user data atom is information appended to the track atom.

The media atom on hierarchical layer 3 comprises a media header atom (mdhd), a media handler reference atom (hdlr) and a media information atom (minf), which are shown on hierarchical layer 4. The media header atom is information on media (audio or video data) recorded in the track atom. The media handler reference atom is information of a handler for decoding the AV data, which is video or audio data.

If the track atom is a video track atom as indicated by notation V on the right side of the figure, the media information atom (minf) on hierarchical layer 4 comprises a video media header atom (vmhd), a data information atom (dinf) and a sample table atom (stbl), which are shown on hierarchical layer 5. If the track atom is an audio track atom as indicated by notation A on the right side of the figure, on the other hand, the media information atom (minf) on hierarchical layer 4 comprises a sound media header atom (smhd), a data information atom (dinf) and a sample table atom (stbl), which are shown on hierarchical layer 5.

The data information atom on hierarchical layer 5 comprises a data reference atom (dref) on hierarchical layer 6. The data reference atom describes the place of the media data by using an alias on hierarchical layer 7.

The sample table atom (stbl) on hierarchical layer 5 is table information used for actually reading out AV data recorded in the movie data atom. On the basis of the table information, the QT software is capable of reading out video and audio data recorded in the movie data atom. It is to be noted that, as described earlier by referring to FIG. 5, in the structure of the QT file, a smallest unit of audio and video data recorded in a movie data atom is referred to as a sample, and a chunk is defined as a set of samples.

If the track atom is a video track atom as indicated by notation V on the right side of the figure, the sample table atom on hierarchical layer 5 comprises a sample description atom (stsd) shown on hierarchical layer 6 and five sample tables, i.e., a time to sample atom (stts), a sync sample atom (stss), a sample to chunk atom (stsc), a sample size atom (stsz) and a chunk offset atom (stco), which are also shown on hierarchical layer 6. If the track atom is an audio track atom as indicated by notation A on the right side of the figure, on the other hand, the sync sample atom is excluded.

If the track atom is a video track atom as indicated by notation V on the right side of the figure, in the case of this embodiment, the sample description atom on hierarchical layer 6 comprises an mpeg4 data format atom (mp4v) on hierarchical layer 7 and an elementary stream description (esds) on hierarchical layer 8. The mpeg4 data format atom (mp4v) describes the format of MPEG4 video data and the elementary stream description (esds) is information required for decoding. If the track atom is an audio track atom as indicated by notation A on the right side of the figure, on the other hand, the sample description atom on hierarchical layer 6 comprises an alaw data format atom (alaw) on hierarchical layer 7. The alaw data format atom (alaw) describes the format of ITU-T G.711 A-Law audio data.

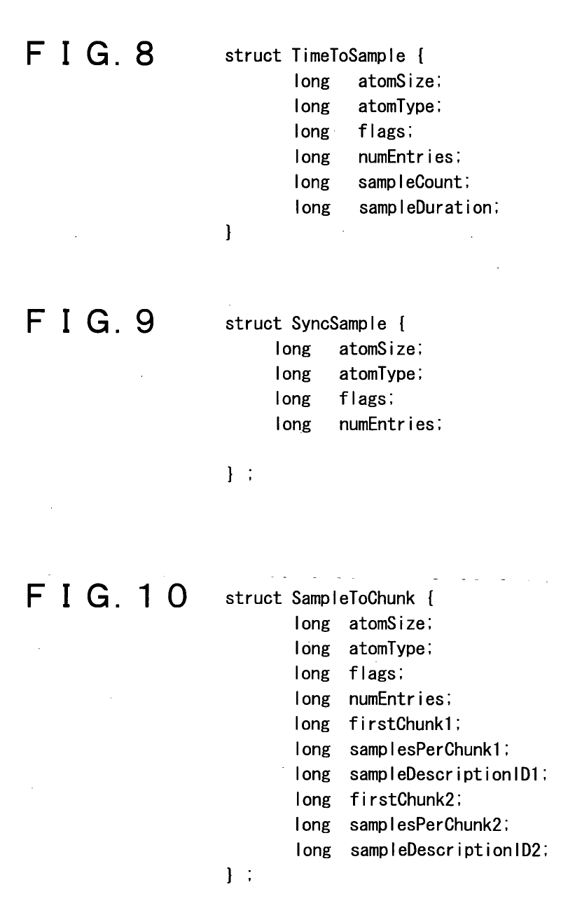

By referring to FIGS. 8 to 12, the following description explains the five sample tables, which are information used in an operation to read out audio and video data recorded in the movie atom 56.

FIG. 8 is a diagram showing a typical time sample atom. The time sample atom is a table showing a time duration obtained as a result of measuring one sample (or one frame) by a timescale of a track atom.

In the case of the typical time sample atom shown in FIG. 8, the time to sample atom (stts) comprises an atom size (atomSize), an atom type (atomType), a flag (flags), an entry count (numEntries), the number of samples (sampleCount) and a sample duration (sampleDuration). The atom size is the size of the time sample atom. The atom type indicates that the type of this atom is an stts (the time sample atom). The first byte of the flag is a version and the rest represents flags. The entry count represents the number of samples and an interval between samples. The number of samples is the number of samples in the track atom. The sample time is the time of one sample.

Assume for example that the sample time (sampleDuration) described in the time sample atom is a hexadecimal number of 0x64. In this case, on the timescale of the track atom, the sample time is 100. Thus, with 1 second set at 2,997, the sample time indicates that 1 second is equivalent to 2,997/100=29.97 samples (frames).

FIG. 9 is a diagram showing a typical sync sample atom. The sync sample atom is a table of a frame key frame serving as a key. The sync sample atom describes information on synchronization.

In the case of the typical structure shown in FIG. 9, the sync sample atom (stss) comprises an atom size (atomSize), an atom type (atomType), a flag (flags) and an entry count (numEntries). The atom size is the size of the sync sample atom. The atom type indicates that the type of this atom is an stss (the synchronization sample atom). The first byte of the flag is a version and the rest represents flags. The entry count represents the number of entries in a sample-number table of I frames composing video data.

For example, a frame can be an I, P or B picture as is the case with the MPEG system. In this case, the sample-number table is a table describing sample numbers of I-picture frames. It is to be noted that, if the track atom is an audio track atom as indicated by notation A on the right side of the figure, the synchronization sample atom does not exist.

FIG. 10 is a diagram showing a typical sample chunk atom. The sample chunk atom is a table indicating data of how many samples (frames) composes all chunks.

In the case of the typical sample chunk atom shown in FIG. 10, the sample to chunk atom (stsc) comprises an atom size (atomSize), an atom type (atomType), a flag (flags), an entry count (numEntries), first chunk 1 (firstChunk1), a sample count of chunk 1 (samplesPerChunk1), an entry number of chunk 1 (sampleDescriptionID1), first chunk 2 (firstChunk2), a sample count of chunk 2 (samplesPerChunk2) and an entry number of chunk 2 (sampleDescriptionID2).

The atom size is the size of the sample chunk atom. The atom type indicates that the type of this atom is an stsc (the sample chunk atom). The first byte of the flag is a version and the rest represents flags. The entry count represents the number of pieces of data put in entries.

First chunk 1 is the number of the first chunk in a chunk group composed of chunks each comprising a uniform number of samples per chunk. The sample count of chunk 1 is the number of samples in chunk 1. The entry number of chunk 1 is the number of entries in chunk 1. If the following chunk is a chunk with a sample count different from the sample count of chunk 1, information on the following chunk includes first chunk 2, a sample count of chunk 2 and an entry number of chunk 2, which are similar to first chunk 1, a sample count of chunk 1 and an entry number of chunk 1 respectively.

As described above, in the sample chunk atom, information on a plurality of chunks each comprising a uniform number of samples per chunk is represented by information on the first chunk having as many samples as samples included in every other chunk.

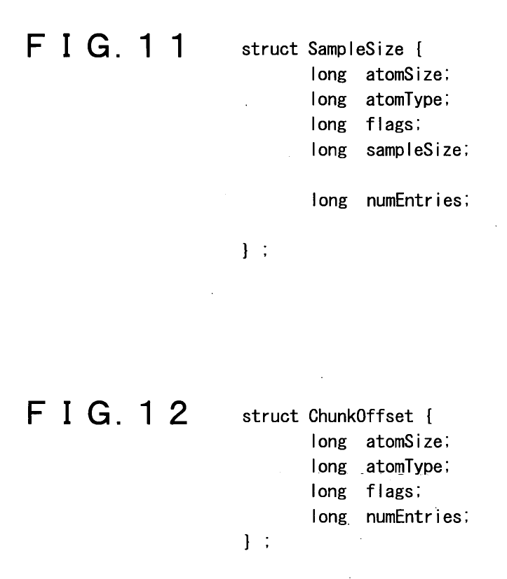

FIG. 11 is a diagram showing a typical sample size atom. The sample size atom is a table describing a data size of every sample.

In the typical structure shown in FIG. 11, the sample size atom (stsz) comprises an atom size (atomSize), an atom type (atomType), a flag (flags), a sample size (sampleSize) and an entry count (numEntries). The atom size is the size of the sample size atom. The atom type indicates that the type of this atom is an stsz (the sample size atom). The first byte of the flag is a version and the rest represents flags. The sample size is the size of a sample. Assume for example that the sample size is uniform. In this case, it is necessary to describe only one value of the uniform sample size. The entry count is the number of entries for the sample size.

Thus, for data with a fixed size as is the case with audio data, for example, as the sample size, a default size is described. If the frame corresponds to the sample as is the case with video data and the size of a sample changes from time to time like an MPEG I or P picture, on the other hand, the sample size is described for every sample.

FIG. 12 is a diagram showing a typical chunk offset atom. The chunk offset atom is a table describing an offset relative to the beginning of a file for every chunk.

In the typical structure shown in FIG. 12, the chunk offset atom (stco) comprises an atom size (atomSize), an atom type (atomType), flags and an entry count (numEntries). The atom size is the size of the sample size atom. The atom type indicates that the type of this atom is an stco (the chunk offset atom). The first byte of the flag is a version and the rest represents flags. The entry count is the number of entries for the offset value of a chunk.

Thus, in the format shown in FIG. 5, for example, as an offset of a chunk of audio data, an offset from the beginning of the file to a chunk start position AC is described and, as an offset of a chunk of video data, an offset from the beginning of the file to a chunk start position VC is described.

On the basis of the movie atom 56 having the structure described above, the QT software instructs a media handler reference atom (hdlr) provided on hierarchical layer 4 as a media handler reference atom corresponding to audio or video data to make an access to media data corresponding to a specific time. To put it concretely, if a specific sample time is given, the media handler atom determines a time based on a timescale of its media. Then, a time in a timescale of each track atom is obtained by means of information of an edit atom (edts) on hierarchical layer 3. Thus, the media handler atom finds a sample number on the basis of the time sample atom on hierarchical layer 6. Then, from a chunk offset atom on hierarchical layer 6, an offset from the beginning of the file is acquired. Thus, since the media handler atom is capable of making an access to the specified sample, the QT software is capable of reproducing video and audio data recorded in the movie data atom 55 in accordance with the timescale.

As described above, the movie atom 56 describes a sample table, which is information required for reading out video and audio data recorded in the movie data atom 55. Thus, on the basis of video and audio data recorded in the movie data atom 55, the movie atom 56 is generated and placed at a location following the file footer in the AV multiplex format so that even the QT software is capable of recognizing a file having the AV multiplex format.

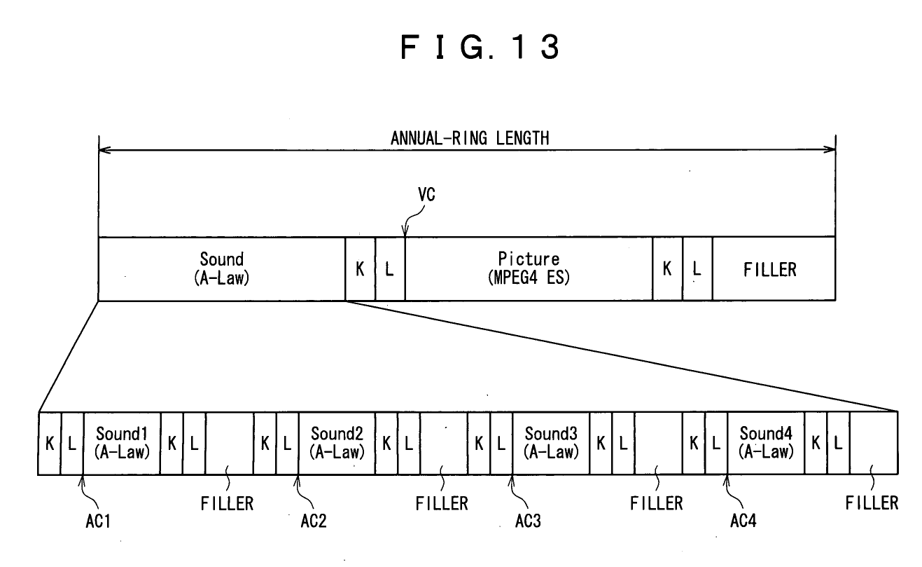

FIG. 13 is a diagram showing a typical file body of an MXF file having the AV multiplex format shown in FIG. 5. In the typical structure shown in FIG. 13, an essence container with a size equal to the length of an annual ring is shown. In actuality, a body partition pack unit is located at the beginning of the essence container but the body partition pack unit is omitted from FIG. 13 showing the typical configuration.

In the case of the typical structure shown in FIG. 13, the essence container having a size equal to the length of an annual ring comprises the aforementioned body partition pack unit not shown in the figure, a sound item (Sound), a picture item (Picture) and a filler. The sound item is referred to hereafter as a sound-item group in order to distinguish the group from a plurality of sound items 1 to 4 composing the group.

Audio data of 60 frames (in the case of the NTSC system) in the sound-item group is divided into four KLV structures described earlier by referring to FIG. 4. In the case of the typical structure shown in FIG. 13, the sound-item group contains audio data encoded by using the ITU-T G.711 A-Law method.

Thus, the sound-item group begins with sound item 1 having a KLV structure, a KLV-structured filler following sound item 1, sound item 2 having a KLV structure, a KLV-structured filler following sound item 2, sound item 3 having a KLV structure, a KLV-structured filler following sound item 3, sound item 4 having a KLV structure and a KLV-structured filler following sound item 4. It is to be noted that a sound item comprises an ECC/2 unit and the filler following the sound item is stuffing data for making the length of the ECC unit fixed.

A picture item following the audio data of the sound-item group contains video data having a size equal to the length of an annual ring. The video data is video data encoded by adopting the MPEG (Moving Picture Experts Group) 4 method. To be more specific, the video data is a result of carrying out a KLV coding process on an ES (elementary stream) to form a KLV structure. A filler with a KLV structure provided at a location following the video data of the picture item is stuffing data for converting the picture item into an ECC unit having a fixed length.

As described above, in the AV multiplex format, sound-item groups are multiplexed with picture items with each sound-item group and a picture item following the group forming a pair with a size equal to the length of an annual ring. Each of the sound-item group contains audio data laid out to form a KLV structure in conformity with the MXF specifications. By the same token, each of the picture items contains video data laid out to form a KLV structure in conformity with the MXF specifications. In the case of the NTSC system, the length of an annual ring is equivalent to 60 frames. Thus, the file generation unit 22 employed in the video-recording apparatus 1 determines a key (K) of the KLV structure and a length (L) from the amount of encoded data, generating an MXF header of the file header of the AV multiplex format. In accordance with what has been described above, the data-editing apparatus 3 and 6 conforming to the MXF specifications are capable of finding an essence container on the basis of the body partition pack unit and reading out audio and video data laid out in a KLV structure from desired locations on the basis of the MXF header of the file header.

In the QT software, on the other hand, audio and video data having structures described above is defined as one chunk. Thus, the file generation unit 22 ignores the key (K) and length (L) of the KLV structure, defining each of sound items 1, 2, 3 and 4 and the picture item as a chunk. Then, the file generation unit 22 finds the offset of the beginning position AC1 of sound item 1, the offset of the beginning position AC2 of sound item 2, the offset of the beginning position AC3 of sound item 3, the offset of the beginning position AC4 of sound item 4 and the offset of the beginning position VC of the picture item to generate a sample table of the movie atom following the file footer. Thus, the PCs 4 and 7 having the QT software are capable of reading out audio and video data defined as a chunk on the basis of the movie atom following the file footer. That is to say, in the movie atom of the QT software, audio and video data is managed as offsets from the beginning of the file as offsets of the stored movie data atom.

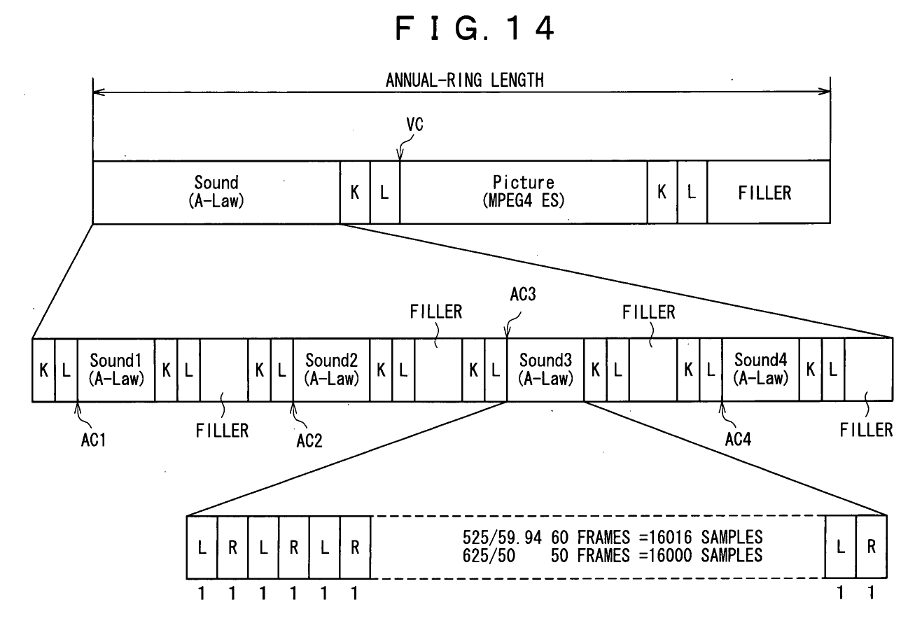

FIG. 14 is a diagram showing an example of sound item (Sound) 3 shown in FIG. 13. In the typical sound item shown in FIG. 14, sound item 3 has a structure including audio data of two channels, i.e., left (L) and right (R) channels.

The audio data of the two channels is a result of multiplexing the audio data of one channel with audio data of the other channel alternately in sample units. Thus, in the case of the 525/59.94 NTSC specifications, since video data is composed of 60 frames, a sound item includes 16,016 samples of audio data. In the case of 625/50 PAL specifications, since video data is composed of 50 frames, a sound item includes 16,000 samples of audio data.

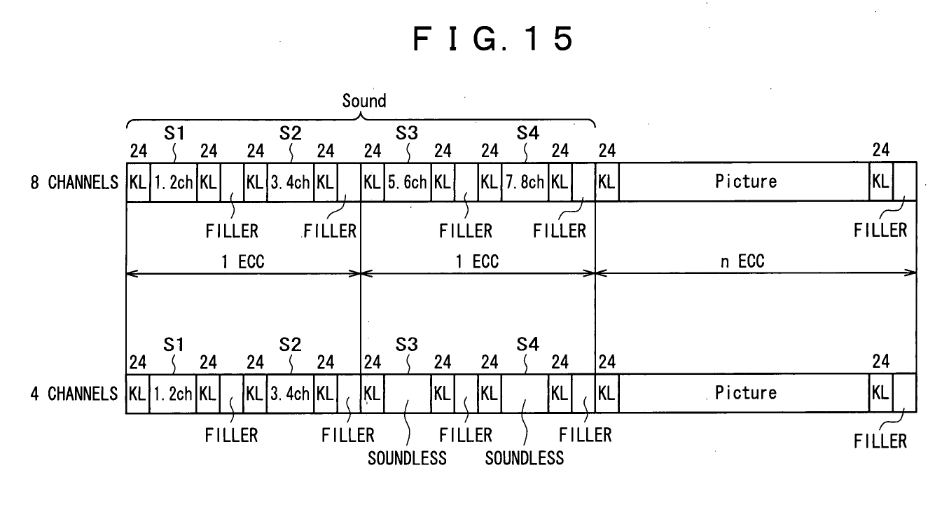

As described above, a sound item includes audio data of two channels. By referring to FIG. 15, the following description thus explains cases in which a sound item includes audio data of four and eight channels.

FIG. 15 is a diagram showing another typical file body of the AV multiplex format shown in FIG. 13. In the case of the typical file body shown in FIG. 15, the sound-item group has a structure comprising 2 ECC fixed lengths while the picture item has a structure comprising n ECC fixed lengths. It is to be noted that the upper portion of the figure is a file body including audio data of eight channels. On the other hand, the lower portion is a file body including audio data of four channels.

As is obvious from the upper portion, in the case of eight-channel audio data, the first 1-ECC of the sound-item group comprises a key (K) and length (L) at the head, sound item 1 (S1) following the length (L), another key (K) and other length (L) following sound item 1, a filler following the other length (L), a further key (K) and further length (L) following the filler, sound item 2 (S2) following the further length (L), a still further key (K) and still further length (L) following sound item 2 and another filler following the still further length (L). Each pair comprising a key (K) and a length (L) has a length of 24 bytes. Sound item 1 comprises samples of audio data of channel 1, which are placed alternately with samples of audio data of channel 2. By the same token, sound item 2 comprises samples of audio data of channel 3, which are placed alternately with samples of audio data of channel 4.

In the same way, the second 1-ECC of the sound-item group comprises a key (K) and length (L) at the head, sound item 3 (S3) following the length (L), another key (K) and other length (L) following sound item 3, a filler following the other length (L), a further key (K) and further length (L) following the filler, sound item 4 (S4) following the further length (L), a still further key (K) and still further length (L) following sound item 4 and another filler following the still further length (L). Likewise, each pair comprising a key (K) and a length (L) has a length of 24 bytes. Similarly, sound item 3 comprises samples of audio data of channel 5, which are placed alternately with samples of audio data of channel 6. By the same token, sound item 4 comprises samples of audio data of channel 7, which are placed alternately with samples of audio data of channel 8.

As is obvious from the lower portion of the figure, in the case of four-channel audio data, on the other hand, the first 1-ECC of the sound-item group comprises a key (K) and length (L) at the head, sound item 1 (S1) following the length (L), another key (K) and other length (L) following sound item 1, a filler following the other length (L), a further key (K) and further length (L) following the filler, sound item 2 (S2) following the further length (L), a still further key (K) and still further length (L) following sound item 2 and another filler following the still further length (L). Each pair comprising a key (K) and a length (L) has a length of 24 bytes. Sound item 1 comprises samples of audio data of channel 1, which are placed alternately with samples of audio data of channel 2. By the same token, sound item 2 comprises samples of audio data of channel 3, which are placed alternately with samples of audio data of channel 4.

On the other hand, the second 1-ECC of the sound-item group comprises a key (K) and length (L) at the head, sound item 3 (S3) following the length (L), another key (K) and other length (L) following sound item 3, a filler following the other length (L), a further key (K) and further length (L) following the filler, sound item 4 (S4) following the further length (L), a still further key (K) and still further length (L) following sound item 4 and another filler following the still further length (L). In the same way, each pair comprising a key (K) and a length (L) has a length of 24 bytes. In this case, however, sound items 3 and 4 each comprise samples of soundless audio data, which are placed alternately.

As described above, in the case of eight-channel audio data, the first 1-ECC and the second 1-ECC each contain audio data of four channels. In the case of four-channel audio data, on the other hand, only the first 1-ECC contains audio data of four channels. Each of the sound items in the second 1-ECC is recorded soundless audio data.

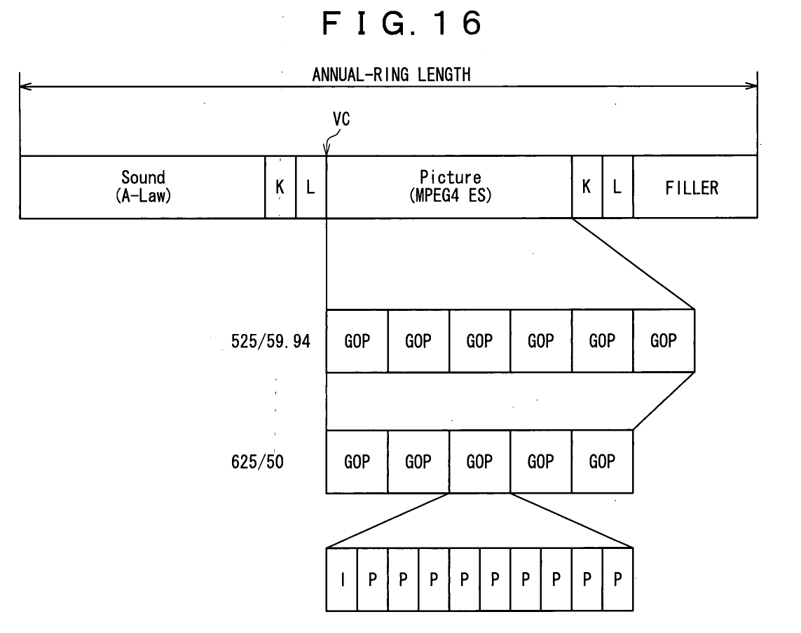

FIG. 16 is a diagram showing a typical picture item shown in FIG. 13. As described above, the picture item with a size equal to the length of one annual ring includes video data of 60 frames (in the case of the NTSC system) encoded by adopting the MPEG4 method. The 60 frames form six GOPs (Groups Of Pictures). To put it concretely, in the case of the 525/59.94 NTSC specifications, video data comprises 60 frames. Since each GOP comprises an I-picture frame and nine P-picture frames, the picture item comprises six GOPs. In the case of the 625/50 PAL specifications, on the other hand, video data comprises 50 frames. Since each GOP comprises an I-picture frame and nine P-picture frames, the picture item comprises five GOPs.

As described above, the essence container of the file body in a file having the AV multiplex format includes video and audio data laid out alternately in units each having a size equal to the length of one annual ring.

By referring to a flowchart shown in FIG. 17, the following description explains a process to generate a file having the AV multiplex format with the structure described above.

The user (operator) operates buttons of the operation unit 24 to transmit shot data in the-on-fly way to the data-editing apparatus 6 or the PC 7 and give a command to record the data onto the optical disk 2. The operation unit 24 passes on the command received from the user to the video-encoding unit 15, the audio-encoding unit 16, the input unit 18 and the file generation unit 22. The flowchart begins with a step S1 at which the file generation unit 22 enters a state of waiting for a command to start a shooting operation. As a command received from the operation unit 24 is determined to be a command to start a shooting operation, the flow of the process goes on to a step S2.

In addition, as the user enters the command to start a shooting operation, initial parameter information is stored in the RAM 13. The initial parameter information includes information indicating the NTSC or PAL system, the length of an annual ring, the number of video-data frames per annual-ring length and the number of audio samples. At the step S2, the file generation unit 22 acquires the initial parameter information stored in the RAM 13. Then, the flow of the process goes on to a step S3.

At the step S3, the file generation unit 22 generates a transmission-use file header on the basis of the acquired initial parameter information. To put it concretely, the transmission-use file header includes an mdat header indicating the size of the movie data atom 54 in the run-in at the beginning of the transmission-use file header. The transmission-use file header is generated to include dummy data representing unknown information in the metadata explained earlier by referring to FIG. 4. The unknown information is information that cannot be acquired until the actual recording operation is completed. An example of the unknown information is a recording duration. A representative value such as −1 or 0, which absolutely never appears as the unknown information cited above, is used as the dummy data. The file generation unit 22 stores the generated transmission-use file header in the memory 33. Then, the flow of the process goes on to a step S4. At the step S4, the file generation unit 22 controls the communication unit 21 to transmit the generated transmission-use file header to the data-editing apparatus 6 by way of the network 5. Then, the flow of the process goes on to a step S5.

In the mean time, in accordance with the command received from the operation unit 24, the imaging unit 31 of the input unit 18 images the object and supplies video data obtained as a result of the imaging operation to the video-encoding unit 15. The video-encoding unit 15 encodes the video data received from the imaging unit 31 by adoption of the MPEG4 method and supplies the encoded video data to the file generation unit 22. At the same time, the microphone 32 supplies collected audio data to the audio-encoding unit 16. The audio-encoding unit 16 encodes the audio data received from the microphone 32 by adoption of the ITU-T G.711 A-Law method and supplies the encoded audio data to the file generation unit 22.

Then, at the next step S5, the file generation unit 22 carries out a file body generation process to generate data of the file body. The file body generation process is explained by referring to a flowchart shown in FIG. 18 as follows.

The video data encoded by the video-encoding unit 15 and the audio data encoded by the audio-encoding unit 16 are supplied to the memory 33 of the file generation unit 22 to be stored therein. At the first step S21 of the flowchart shown in FIG. 18, the file generation unit 22 enters a state of waiting for AV data with an amount equal to the length of one annual ring to be stored in the memory 33. The AV data comprises the video and audio data mentioned above. As AV data with an amount equal to the length of one annual ring is determined to have been stored in the memory 33, the flow of the process goes on to a step S22 at which annual-ring data 51 having an amount equal to the length of one annual ring is generated by creating an essence container 53 with a size equal to the length of one annual ring from the stored AV data and creating a body partition pack unit 52 including the mdat header of the movie data atom 55.

To put it in detail, the file generation unit 22 creates the essence container 53 having the AV multiplex format described earlier by referring to FIGS. 12 to 16 by alternately multiplexing audio data with 60 frames (in the case of the NTSC system) of video data in the annual-ring data 51 having an amount equal to the length of one annual ring. Then, the file generation unit 22 generates the body partition pack unit 52 by creating a body partition pack, which includes its own offset relative to the beginning of the file and an offset included in the preceding body partition pack unit. Then, the mdat header including the size of the movie data atom 55 is created as a header preceding a movie data atom 55. The size of the movie data atom 55 is equal to the length of one annual ring. Subsequently, the file generation unit 22 supplies the annual-ring data 51 having an amount equal to the length of one annual ring to the communication unit 21 and the drive 23. As described above, the annual-ring data comprises the body partition pack unit 52 and the essence container 53. Then, the flow of the process goes on to a step S23.

Then, at the next step S23, the file generation unit 22 acquires the frame size of the video data included in the generated file body as video data in the annual-ring data 51 having an amount equal to the length of one annual ring and stores the frame size in the memory 33. Then, the flow of the process goes on to a step S24.

At the step S24, the communication unit 21 transmits the annual-ring data 51 included in the file body generated by the file generation unit 22 as annual-ring data 51 having an amount equal to the length of one annual ring to the data-editing apparatus 6 by way of the network 5. Then, the flow of the process goes on to a step S25.

At the step S25, the drive 23 stores the annual-ring data 51 included in the file body generated by the file generation unit 22 as annual-ring data 51 having an amount equal to the length of one annual ring onto the optical disk 2. Then, the flow of the process goes on to a step S26. At that time, the first body partition pack unit 52-1 is described as a portion of a filler included in the file header. This filler is shown in none of the figures. Thus, in an operation to record the first annual-ring data 51-1, considering an ECC portion including a stored recording-use file header, the drive 23 uses the boundary of a predetermined ECC as a recording start point of the file body and records the first body partition pack unit 52-1 preceding the recording start point onto the optical disk 2 so that the first essence container 53-1 can be recorded. It is to be noted that data starting with the next annual-ring data 51-2 is recorded onto the optical disk 2 to follow the preceding the annual-ring data 51-1.

Then, at the step S26, the file generation unit 22 determines whether or not the process has been carried out on all the AV data, that is, whether or not the shooting operation has been completed. It is to be noted that, if the process is still being carried out on some AV data, the video data encoded by the video-encoding unit 15 and the audio data encoded by the audio-encoding unit 16 are still supplied to the memory 33 of the file generation unit 22 to be stored there in. Thus, the file generation unit 22 determines that the process carried out on the AV data has not been completed. In this case, the flow of the process goes back to the step S21 to repeat the process starting with the step.

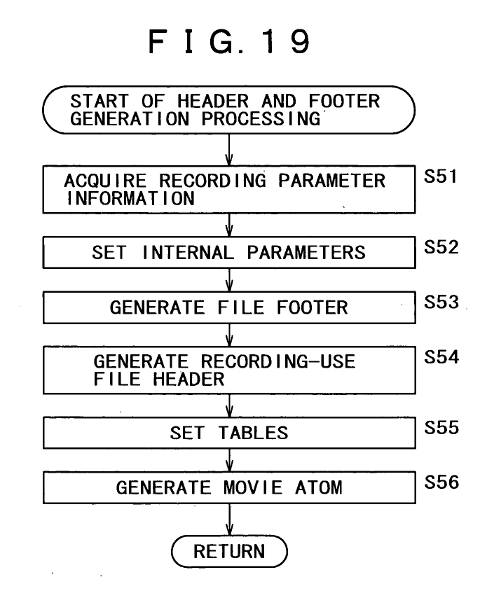

If the file generation unit 22 determines at the step S26 that the process carried out on the AV data has been completed, on the other hand, the flow of the process goes back to a step S6 of the flowchart shown in FIG. 17 to carry out a process to generate a header and a footer. The process to generate a header and a footer is explained by referring to a flowchart shown in FIG. 19 as follows.

Recording parameter information determined after the step S5 of the flowchart shown in FIG. 17 to generate a file body has been stored in the RAM 13 as parameter information related to AV data obtained as a result of the imaging operation. The recording parameter information includes parameter information indicating the NTSC or PAL system, the length of an annual ring, the number of video-data frames per annual-ring length, the number of audio samples and the recording duration. That is to say, the recording parameter information includes the initial parameter information acquired at the step S2 at the beginning of the recording operation and recording information stored in the RAM 13 after the file body has been recorded onto the optical disk 2. The recording information includes the recording duration mentioned above.

At the first step S51 of the flowchart shown in FIG. 19, the file generation unit 22 reads out the recording parameter information from the RAM 13. Then, the flow of the process goes on to a step S52. At the step S52, the file generation unit 22 sets internal parameters on the basis of the acquired recording parameter information and the frame size recorded at the step S23 of the flowchart shown in FIG. 18. Then, the flow of the process goes on to a step S53. The internal parameters typically comprise the size of a GOP and time information such as a timescale.

At the step S53, the file generation unit 22 generates a file footer on the basis of the set internal parameters and stores the file footer in the memory 33. In actuality, at this step, the file generation unit 22 generates a transmission-use file footer and an ordinary file footer. It is to be noted that the ordinary file footer is also referred to hereafter as a recording-use file footer. The transmission-use file footer is a file footer including actual values of the dummy data of the header metadata included in the transmission-use file header created at the step S3 of the flowchart shown in FIG. 17. On the other hand, the ordinary file footer is a file footer not describing the actual values of the dummy data of the header metadata. Then, the flow of the process goes on to a step S54.

At the step S54, the file generation unit 22 generates an ordinary file header on the basis of the set internal parameters and stores the file header in the memory 33. The ordinary file header is a header accurately describing information such as the recording duration. It is to be noted that the ordinary file header is also referred to hereafter as a recording-use file header. Then, the flow of the process goes on to a step S55. At the step S55, the file generation unit 22 sets a sample table of each track atom of the movie atom on the basis of the movie data atom generated at the step S5 of the flowchart shown in FIG. 17 and the set internal parameters. Then, the flow of the process goes on to a step S56 at which, on the basis of values of the set sample tables, the file generation unit 22 computes an atom size and generates a movie atom, storing them in the memory 33. Then, the flow of the process goes back to a step S7 of the flowchart shown in FIG. 17.

At the step S7 of the flowchart shown in FIG. 17, the file generation unit 22 reads out the transmission-use file footer and the movie atom, which were generated at the step S6, from the memory 33 and controls the communication unit 21 to transmit them to the data-editing apparatus 6 by way of the network 5. Then, the flow of the process goes on to a step S8.

At the step S8, the file generation unit 22 reads out the recording-use file footer and the movie atom, which were generated at the step S6, from the memory 33 and controls the drive 23 to record them onto the optical disk 2. To put it concretely, the drive 23 records the recording-use file footer and the movie atom at a location following the file body recorded on the optical disk 2 at the step S3, linking them to the file body. Then, the flow of the process goes on to a step S9.

At the step S9, the file generation unit 22 reads out the recording-use file header generated at the step S6 from the memory 33 and controls the drive 23 to record the header onto the optical disk 2, ending the file generation process. To put it concretely, the drive 23 records the recording-use file header at a location preceding the file body recorded on the optical disk 2 at the step S3, linking the header to the file body. At this point of time, the process to record the file having the AV multiplex format onto the optical disk 2 is completed.

As described above, the file body is generated by creating the essence container of every annual-ring data having a size equal to the annual-ring length set in advance. Thus, the size of every movie data atom can be acquired. Accordingly, even if an object is shot and transmitted to the data-editing apparatus 6 or the PC 7 in an on-the-fly manner, the structure of the QT file is sustained. Thus, the PC 7 having the QT software receives the file having the AV multiplex format as a file transmitted in an on-the-fly manner and is capable of reproducing the file by using the QT software. That is to say, when the operation to receive the file having the AV multiplex format is completed, the data-editing apparatus 6 is capable of reading out the movie atom of the file having the AV multiplex format, finding an offset of a chunk of every essence container on the basis of each piece of table information in the movie atom and reproducing AV data recorded in the chunk of every essence container from the offset.

It is obvious from the above description that the data-editing apparatus 3 conforming to the MXF specifications is capable of receiving the file having the AV multiplex format, that is, a file also transmitted in an on-the-fly manner, and sequentially reproducing the file from its beginning in a real-time manner on the basis of the transmission-use file header. That is to say, since the data-editing apparatus 3 is capable of acquiring minimum reproduction information required for reproducing the file from its beginning from the transmission-use file header, AV data of every received essence container in the annual-ring data with a size equal to the length of one annual ring can be reproduced in a real-time manner.

In addition, as described above, the file having the AV multiplex format is recorded onto the optical disk 2. Thus, the file having the AV multiplex format can be exchanged between the video-recording apparatus 1 and the data-editing apparatus 3 or the PC 4 by using the optical disk 2.

That is to say, a file having the AV multiplex format can be exchanged between the video-recording apparatus 1, the data-editing apparatus 3 and 6 each conforming to the MXF specifications as well as the PCs 4 and 7 as a file having the AV multiplex format.

On the top of that, as described above, a generated file having the AV multiplex format can be transmitted in a real-time manner and recorded onto the optical disk 2. Thus, the transmission and recording processes can be carried out with a higher degree of efficiency.

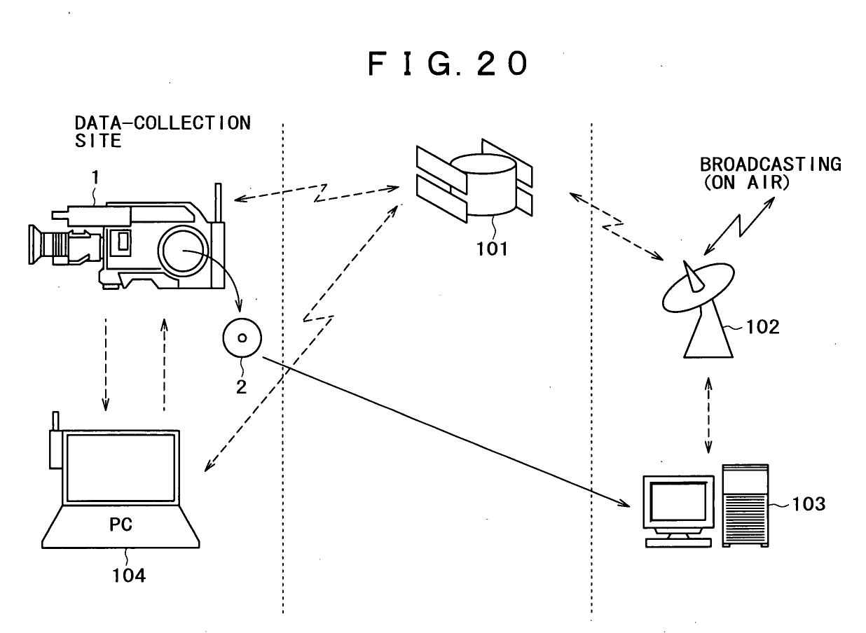

FIG. 20 is a diagram showing another typical configuration of an AV network system provided by the present invention. It is to be noted that, in FIG. 20, elements identical with their counterparts employed in the AV network system shown in FIG. 1 are denoted by the same reference numerals as the counterparts and the explanations of the counterparts are not repeated for describing the identical elements to avoid duplications.

In the other typical configuration of an AV network system shown in FIG. 20, the video-recording apparatus 1 images a video and inputs sounds in conjunction with a PC 104 having the QT software. The video-recording apparatus 1 and the PC 104 are thus carried to a data-collection site, being set thereat.

The imaging unit 31 employed in the video-recording apparatus 1 images an object and supplies video data produced as a result of imaging to the video-encoding unit 15. The video-encoding unit 15 encodes the video data received from the imaging unit 31 into video data with a high resolution for the purpose of broadcasting in a broadcasting station and into video data with a low resolution and a small amount, which are intended for communication and editing purposes, and supplies the encoded video data to the file generation unit 22. The resolution for communication and editing purposes is lower than the resolution of the high-resolution video data for the purpose of broadcasting. In addition, the amount of video data for communication and editing purposes is smaller than the amount of the high-resolution video data for the purpose of broadcasting. On the other hand, the microphone 32 supplies collected audio data to the audio-encoding unit 16. The audio-encoding unit 16 encodes the audio data received from the microphone 32 into audio data with a high sound quality for the purpose of broadcasting in a broadcasting station and into audio data with a low sound quality and a small amount, which are intended for communication and editing purposes, and supplies the encoded audio data to the file generation unit 22. The sound quality for communication and editing purposes is lower than the sound quality of the audio data with the high sound quality for the purpose of broadcasting. In addition, the amount of audio data for communication and editing purposes is smaller than the amount of the audio data with the high sound quality for the purpose of broadcasting.

The file generation unit 22 generates high-quality and low-quality files each having the AV multiplex format from high-resolution and low-resolution video data received from the video-encoding unit 15 as well as audio data received from the audio-encoding unit 16 as audio data with high and low sound qualities. The file generation unit 22 then controls the drive 23 to record the files each having the AV multiplex format onto the optical disk 2. It is to be noted that the encoded video data and the encoded audio data are recorded onto the optical disk 2 concurrently with the shooting operation. As an alternative, the encoded video data as well as the encoded audio data can be temporarily stored in the storage unit 20, and read out later in an operation to generate the files, which are finally recorded onto the optical disk 2.

In addition, the file generation unit 22 also supplies the low-quality file having the AV multiplex format to the communication unit 21 concurrently with the shooting operation as well as the process to supply the file having the AV multiplex format to the drive 23. The file generation unit 22 then controls the communication unit 21 to transmit the file generated to comprise units each having a size equal to the length of one annual ring as a file having the AV multiplex format to a broadcasting station 102 by way of a communication satellite 101 each time the file is supplied to the communication unit 21.

The broadcasting station 102 has a data-editing apparatus 103. Much like the data-editing apparatus 3 and 6 shown in FIG. 1, the data-editing apparatus 103 has a configuration conforming to the MXF specifications. The data-editing apparatus 103 is capable of recognizing a transmission-use file header of a received low-quality file having the AV multiplex format. Then, the data-editing apparatus 103 reproduces audio and video data of the low-quality file having the AV multiplex format in a real-time manner starting from the beginning of the file on the basis of the transmission-use file header. In addition, after the file reception process is completed, the data-editing apparatus 103 can be used for editing the audio and video data of the low-quality file having the AV multiplex format to accommodate the data in a predetermined broadcasting time duration, carrying out image processing for scene switching and performing an editing process such as processing to create a text including an added script or the like. Then, the data-editing apparatus 103 transmits a result of editing the audio and video data of the low-quality file having the AV multiplex format to the video-recording apparatus 1 by way of the communication satellite 101 as an edit list.

It is to be noted that the video-recording apparatus 1 may transmit the low-quality file having the AV multiplex format to a PC 104 functioning as a data-editing apparatus located in the vicinity of the video-recording apparatus 1. The PC 104 allows an editing process to be carried out while a producer or the like is verifying the state of recording.

The PC 104 has a configuration similar to those of the PCs 4 and 7 and also has the QT software. Thus, the PC 104 is capable of receiving a low-quality file having the AV multiplex format transmitted from the video-recording apparatus 1 and, as the file reception process is completed, capable of reproducing and editing the file by using the QT software. Then, the PC 104 transmits a result of editing the audio and video data of the low-quality file having the AV multiplex format as an edit list to the video-recording apparatus 1 by way of the communication satellite 101 or by short-distance radio communication such as Bluetooth (a trademark). That is to say, the general-purpose and portable PC 104 can be used for verifying and editing a low-quality file having the AV multiplex format without, for example, the need to take an expensive special-purpose data-editing apparatus 103 to the data-collection site.

The communication unit 21 employed in the video-recording apparatus 1 receives an edit list from the data-editing apparatus 103 or the PC 104. The CPU 11 controls the drive 23 to record the edit list received from the communication unit 21 onto the optical disk 2. It is to be noted that, at that time, the edit list is recorded in typically the header metadata of the file header. After the processes to record the high-quality and low-quality files each having the AV multiplex format and the edit list are completed, the optical disk 2 is taken to the broadcasting station 102.

The data-editing apparatus 103 employed in the broadcasting station 102 reads out video and audio data from the optical disk 2 as video data having a high resolution and audio data having a high sound quality and decodes the data. The data-editing apparatus 103 then broadcasts (puts on the air) the result of decoding in accordance with the edit list recorded on the optical disk 2.

As described above, high-quality and low-quality files each having the AV multiplex format are recorded onto the optical disk 2. It is to be noted, however, that the optical disk 2 can also be used for recording only one of the files, and the other file is recorded onto another recording medium such as a memory card employing a semiconductor memory. For example, only the high-quality file having the AV multiplex format is recorded onto the optical disk 2. In this case, the low-quality file having the AV multiplex format is recorded onto the other recording medium.

In addition, while the broadcasting station 102 has the data-editing apparatus 103 as described above, the broadcasting station 102 may also employ a PC 104 as a substitute for the data-editing apparatus 103. Conversely, a data-editing apparatus 103 can be used to replace the PC 104 at the data-collection site.

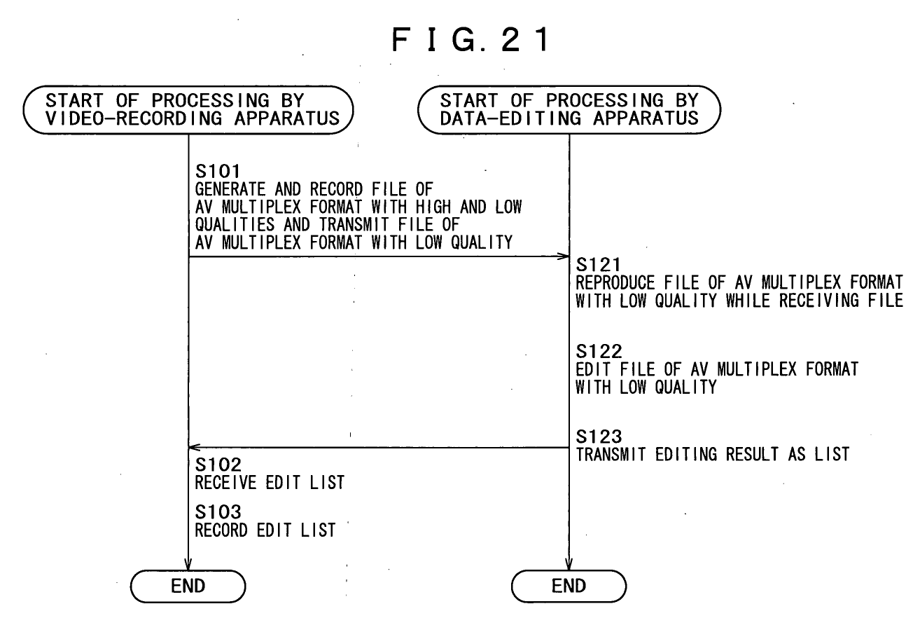

Next, by referring to a flowchart shown in FIG. 21, processing carried out by the AV network system shown in FIG. 20 is explained. It is to be noted that, to be more specific, FIG. 21 shows a flowchart representing processes carried out by the video-recording apparatus 1 and the data-editing apparatus 103.

While imaging an object, the imaging unit 31 employed in the video-recording apparatus 1 supplies video data obtained as a result of imaging to the video-encoding unit 15. The video-encoding unit 15 encodes the video data received from the imaging unit 31 into data having high and low resolutions, supplying the encoded data to the file generation unit 22. In the mean time, the microphone 32 supplies collected audio data to the audio-encoding unit 16. The audio-encoding unit 16 encodes the audio data received from the microphone 32 into data having high and low sound qualities, supplying the encoded data to the file generation unit 22.

At the first step S101 of the flowchart shown in FIG. 21, the file generation unit 22 employed in the video-recording apparatus 1 generates a file having the AV multiplex format from the video and audio data. The file generation unit 22 then controls the drive 23 to record the file onto the optical disk 2. At the same time, the file generation unit 22 controls the communication unit 21 to transmit the generated file having the AV multiplex format to the data-editing apparatus 103 typically by way of the communication satellite 101. Then, the flow of the processing goes on to a step S102.

To put it concretely, the file generation unit 22 generates high-quality and low-quality files each having the AV multiplex format from respectively high-resolution and low-resolution video data received from the video-encoding unit 15 as well as audio data received from the audio-encoding unit 16 as audio data with high and low sound qualities. The file generation unit 22 then controls the drive 23 to record the files each having the AV multiplex format onto the optical disk 2. At the same time, the file generation unit 22 controls the communication unit 21 to transmit the generated low-quality file having the AV multiplex format to the data-editing apparatus 103 typically by way of the communication satellite 101.

On the other hand, at a step S121, the data-editing apparatus 103 reproduces audio and video data of the low-quality file having the AV multiplex format in a real-time manner starting from the beginning of the file on the basis of the transmission-use file header conforming to the MXF specifications while receiving the file having the AV multiplex format. Then, the flow of the processing goes on to a step S122. At the step S122, the data-editing apparatus 103 is used for editing the audio and video data of the low-quality file having the AV multiplex format. Then, the flow of the processing goes on to a step S123 at which the data-editing apparatus 103 transmits a result of editing the audio and video data of the low-quality file having the AV multiplex format as an edit list to the video-recording apparatus 1 by way of the communication satellite 101.

At the step S102, the communication unit 21 employed in the video-recording apparatus 1 receives the edit list from the data-editing apparatus 103. Then, the flow of the processing goes on to a step S103 at which the received edit list is stored onto the optical disk 2.

Since the optical disk 2 is also taken to the broadcasting station 102, the broadcasting station 102 reads out video data having a high resolution and audio data having a high sound quality from the optical disk 2, broadcasting the data in accordance with the edit list stored on the optical disk 2.

As described above, by using the AV multiplex format, the data-editing apparatus 103 conforming to the MXF specifications is capable of carrying out a reproduction process in a real-time manner. In addition, by using the AV multiplex format of the low quality, communication and editing loads can be reduced.

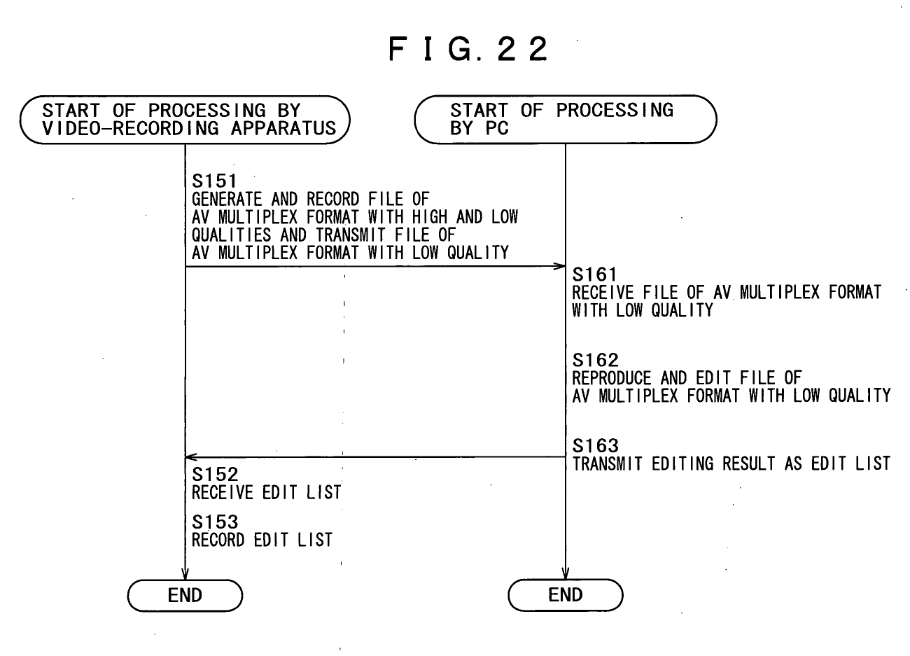

Next, by referring to a flowchart shown in FIG. 22, other processing carried out by the AV network system shown in FIG. 20 is explained. It is to be noted that, to be more specific, FIG. 22 shows a flowchart representing processes carried out by the video-recording apparatus 1 and the PC 104. It is also worth noting that processes carried out at steps S151 to S153 of the flowchart shown in FIG. 22 are the same as the processes carried out at steps S101 to S103 of the flowchart shown in FIG. 21 so that detailed explanations of the processes are not repeated to avoid duplications.

At the first step S151 of the flowchart shown in FIG. 22, the file generation unit 22 employed in the video-recording apparatus 1 generates a file having the AV multiplex format from the video and audio data. The file generation unit 22 then controls the drive 23 to record the file onto the optical disk 2. At the same time, the file generation unit 22 controls the communication unit 21 to transmit the generated file having the AV multiplex format to the PC 104 typically by short-distance radio communication. Then, the flow of the processing goes on to a step S152.

On the other hand, at a step S161, the PC 104 receives the low-quality file having the AV multiplex format. As the process to receive the low-quality file having the AV multiplex format is completed, the flow of the processing goes on to a step S162. At the step S162, the PC 104 reproduces and edits the audio and video data of the low-quality file having the AV multiplex format by using the QT software. Then, the flow of the processing goes on to a step S163 at which the PC 104 transmits a result of editing the audio and video data of the low-quality file having the AV multiplex format as an edit list to the video-recording apparatus 1 by short-distance radio communication.

At the step S152, the communication unit 21 employed in the video-recording apparatus 1 receives the edit list from the PC 104. Then, the flow of the processing goes on to a step S153 at which the received edit list is stored onto the optical disk 2.

As described above, the AV multiplex format having the structure of a QT file is used. Thus, even if the file is transferred in an on-the-fly manner while imaging an object, the PC 104 is capable of carrying out processing to recognize and edit the file having the AV multiplex format. In addition, by using the AV multiplex format of a low quality, communication and editing loads can be reduced.

By carrying out the processing described above, the time it takes to broadcast a recorded file can be shortened. In addition, since the PC 104 having general-purpose characteristics can be used, the shooting cost can be decreased.

As described above, the video-recording apparatus generates a file having the AV multiplex format. It is to be noted, however, that the data-editing apparatus and the PC can also be used for generating a file having the AV multiplex format from stored data or data read out from another recording medium.

In addition, in the video-recording apparatus implemented by this embodiment, a file with the AV multiplex format is written into an optical disk. However, means for storing a file with the AV multiplex format is not limited to a disk-shaped recording medium such as an optical disk. For example, a file with the AV multiplex format can be stored in a tape-shaped recording medium such as a magnetic tape or a semiconductor memory.

The processing sequence described above can be carried out by using hardware or software. If the processing sequence is to be carried out by using software, programs composing the software are installed typically from program-recording media into a computer embedded in special-purpose hardware. Such programs can also be installed into a general-purpose personal computer capable of carrying out a variety of functions by execution of the installed programs.

The program-recording media for storing the programs to be installed into a computer or a general-purpose personal computer in a computer-executable state can be package media such as the optical disk 2 or the storage unit 20, both of which are shown in FIG. 2. The storage unit 20 is used for storing the programs temporarily or permanently.

It is to be noted that the technical term “network” used in this specification is a kind of mechanism for connecting at least two apparatus to each other so that information can be propagated from any one of the apparatus to the other apparatus. Thus, the network can of course be the Internet or an intranet or even a satellite or radio communication means to mention a few. Apparatus communicating information by way of the network can be independent apparatus, or information can be communicated through the network between internal blocks composing an apparatus.

It is to be noted that, in this specification, steps prescribing a program stored in a recording medium can of course be executed sequentially along the time axis in a predetermined order. It is also worth noting, however, that the steps do not have to be executed sequentially along the time axis in a predetermined order. Instead, the steps may include pieces of processing to be carried out concurrently or individually.

In addition, a system in this specification means the entire system comprising a plurality of apparatus logically connected to each other.

1. An information-processing apparatus for generating a file having a format including a header, a body following the header and a footer following the body, said information-processing apparatus comprising:
data determination means for determining whether or not data of an amount equal to a predetermined unit has been stored in a memory;
body generation means for generating data composing the body for each of the predetermined units in case said data determination means determines that data of an amount equal to the predetermined unit has been stored in the memory;
size acquisition means for acquiring the size of data generated by said body generation means as data composing the body; and
table generation means for generating table information to be placed after the footer on the basis of the size acquired by said size acquisition means as table information for reading out data composing the body.

2. An information-processing apparatus according to claim 1, wherein the header comprises a transmission-use header generated as a header for transmitting the file in a real-time manner before the body is generated by said body generation means or a recording-use header generated as a header for recording the file after the body is generated by said body generation means.

3. An information-processing apparatus according to claim 2, further comprising:
header transmission means for transmitting the transmission-use header to an other information-processing apparatus;
body transmission means for transmitting data composing the body generated for each of the predetermined units to the other information-processing apparatus when the data composing the body is generated by said body generation means after the transmission-use header is transmitted by said header transmission means; and
footer transmission means for transmitting the footer and the table information generated by said table generation means to the other information-processing apparatus after the body is transmitted by said body transmission means.

4. An information-processing apparatus according to claim 2, further comprising:
body recording means for recording data composing the body generated for each of the predetermined units into a recording medium when data composing the body is generated by said body generation means;
footer recording means for recording the footer and the table information at a location following the body recorded in the recording medium by said body recording means; and
header recording means for recording the recording-use header at a location in front of the body recorded in the recording medium by said body recording means.

5. An information-processing method for generating a file having a format including a header, a body following the header and a footer following the body, said information-processing method comprising:
a data determination step of determining whether or not data of an amount equal to a predetermined unit has been stored in a memory;
a body generation step of generating data composing the body for each of the predetermined units in case processing carried out at said data determination step produces a determination result indicating that data of an amount equal to the predetermined unit has been stored in the memory;
a size acquisition step of acquiring the size of data generated in processing carried out at said body generation step as data composing the body; and
a table generation step of generating table information to be placed after the footer on the basis of the size acquired in processing carried out at said size acquisition step as table information for reading out data composing the body.

6. An information-processing method according to claim 5, wherein the header comprises a transmission-use header generated as a header for transmitting the file in a real-time manner before the body is generated in processing carried out at said body generation step or a recording-use header generated as a header for recording the file after the body is generated in processing carried out at said body generation step.

7. An information-processing method according to claim 6, further comprising:
a header transmission step of transmitting the transmission-use header to an information-processing apparatus;
a body transmission step of transmitting data composing the body generated for each of the predetermined units to the information-processing apparatus when the data composing the body is generated in processing carried out at said body generation step after the transmission-use header is transmitted in processing carried out at said header transmission step; and
a footer transmission step of transmitting the footer and the table information generated in processing carried out at said table generation step to the information-processing apparatus after the body is transmitted in processing carried out at said body transmission step.

8. An information-processing method according to claim 6, further comprising:
a body recording step of recording data composing the body generated for each of the predetermined units into a recording medium when data composing the body is generated in processing carried out at said body generation step;
a footer recording step of recording the footer and the table information at a location following the body recorded in the recording medium in processing carried out at said body recording step; and
a header recording step of recording the recording-use header at a location in front of the body recorded in the recording medium in processing carried out at said body recording step.

9. A program-recording medium for storing a program to be executed by a computer to carry out a process of generating a file having a format including a header, a body and a footer, wherein said program comprises:
a data determination step of determining whether or not data of an amount equal to a predetermined unit has been stored in a memory;
a body generation step of generating data composing the body for each of the predetermined units in case processing carried out at said data determination step produces a determination result indicating that data of an amount equal to the predetermined unit has been stored in the memory;
a size acquisition step of acquiring the size of data generated in processing carried out at said body generation step as data composing the body; and
a table generation step of generating table information to be placed after the footer on the basis of the size acquired in processing carried out at said size acquisition step as table information for reading out data composing the body.

10. A program-recording medium according to claim 9, wherein the header comprises a transmission-use header generated as a header for transmitting the file in a real-time manner before the body is generated in processing carried out at said body generation step or a recording-use header generated as a header for recording the file after the body is generated in processing carried out at said body generation step.

11. A program-recording medium according to claim 10, wherein said program further comprises:
a header transmission step of transmitting the transmission-use header to an information-processing apparatus;
a body transmission step of transmitting data composing the body generated for each of the predetermined units to the information-processing apparatus when the data composing the body is generated in processing carried out at said body generation step after the transmission-use header is transmitted in processing carried out at said header transmission step; and
a footer transmission step of transmitting the footer and the table information generated in processing carried out at said table generation step to the information-processing apparatus after the body is transmitted in processing carried out at said body transmission step.

12. A program-recording medium according to claim 10, wherein said program further comprises:
a body recording step of recording data composing the body generated for each of the predetermined units into a recording medium when data composing the body is generated in processing carried out at said body generation step;
a footer recording step of recording the footer and the table information at a location following the body recorded in the recording medium in processing carried out at said body recording step; and
a header recording step of recording the recording-use header at a location in front of the body recorded in the recording medium in processing carried out at said body recording step.

13. A program to be executed by a computer to carry out a process of generating a file having a format including a header, a body and a footer, said program comprising:
a data determination step of determining whether or not data of an amount equal to a predetermined unit has been stored in a memory;
a body generation step of generating data composing the body for each of the predetermined units in case processing carried out at said data determination step produces a determination result indicating that data of an amount equal to the predetermined unit has been stored in the memory;
a size acquisition step of acquiring the size of data generated in processing carried out at said body generation step as data composing the body; and
a table generation step of generating table information to be placed after the footer on the basis of the size acquired in processing carried out at said size acquisition step as table information for reading out data composing the body.

14. A program according to claim 13, wherein the header comprises a transmission-use header generated as a header for transmitting the file in a real-time manner before the body is generated in processing carried out at said body generation step or a recording-use header generated as a header for recording the file after the body is generated in processing carried out at said body generation step.

15. A program according to claim 14, further comprising:
a header transmission step of transmitting the transmission-use header to an information-processing apparatus;
a body transmission step of transmitting data composing the body generated for each of the predetermined units to the information-processing apparatus when the data composing the body is generated in processing carried out at said body generation step after the transmission-use header is transmitted in processing carried out at said header transmission step; and
a footer transmission step of transmitting the footer and the table information generated in processing carried out at said table generation step to the information-processing apparatus after the body is transmitted in processing carried out at said body transmission step.

16. A program according to claim 14, further comprising:
a body recording step of recording data composing the body generated for each of the predetermined units into a recording medium when data composing the body is generated in processing carried out at said body generation step;
a footer recording step of recording the footer and the table information at a location following the body recorded in the recording medium in processing carried out at said body recording step; and
a header recording step of recording the recording-use header at a location in front of the body recorded in the recording medium in processing carried out at said body recording step.
